(19) United States
(12) Patent Application Publication
(10) Pub. No.: US 2010/0255420 A1
(43) Pub. Date: Oct. 7, 2010

(54) RADIATION SENSITIVE RESIN COMPOSITION AND POLYMER

(75) Inventors: Hirokazu Sakakibara, Tokyo (JP); Makoto Shimizu, Tokyo (JP); Takehiko Naruoka, Tokyo (JP); Yoshifumi Ooizumi, Tokyo (JP); Kentarou Harada, Tokyo (JP); Takuma Ebata, Tokyo (JP)

Correspondence Address: Ditthavong Mori & Steiner, P.C., 918 Prince Street, Alexandria, VA, 22314, US

(73) Assignee: JSR CORPORATION, Tokyo (JP)

(21) Appl. No.: 12/740,111

(22) PCT Filed: Oct. 21, 2008
(86) PCT No.: PCT/JP2008/069062

§ 371 Date: Apr. 28, 2010

(30) Foreign Application Priority Data
Oct. 29, 2007 (JP) 2007-280971

(51) Int. Cl. G03C 1/00; C08F 118/02

(52) U.S. Cl. 430/285.1; 526/319

(57) ABSTRACT

A radiation-sensitive resin composition includes a polymer, an acid-labile group-containing resin, a radiation-sensitive acid generator, and a solvent, the polymer including repeating units shown by following general formulas (1) and (2).

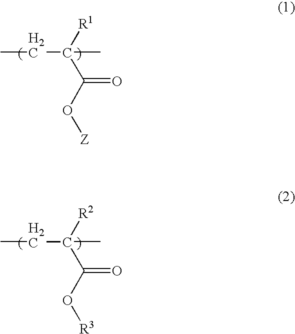

wherein R¹ and R² represent a hydrogen atom, a methyl group, or a trifluoromethyl group, R³ represents a linear or branched alkyl group having 1 to 6 carbon atoms or an alicyclic hydrocarbon group having 4 to 20 carbon atoms in which at least one hydrogen atom is substituted with a fluorine atom, or a derivative thereof, and Z represents a group that includes a group that generates an acid upon exposure to light. The radiation-sensitive resin composition produces an excellent pattern shape, reduces the amount of elution into an immersion liquid upon contact during liquid immersion lithography, ensures that a high receding contact angle is formed by a resist film and an immersion liquid, and rarely causes development defects.

### TECHNICAL FIELD

The present invention relates to a radiation-sensitive resin composition and a polymer. More particularly, the present invention relates to a radiation-sensitive resin composition that may be suitably used as a resist for liquid immersion lithography that exposes a resist film through an immersion liquid (e.g., water), and a novel polymer used for the radiation-sensitive resin composition.

### BACKGROUND ART

In the field of microfabrication represented by production of integrated circuit devices, lithographic technology that enables microfabrication with a line width of 0.10 μm or less has been desired to achieve a higher degree of integration. A lithographic process has utilized near ultraviolet rays (e.g., i-line). However, it is difficult to implement sub-quarter-micron microfabrication using near ultraviolet rays. Therefore, use of radiation having a shorter wavelength has been studied to enable microfabrication with a line width of 0.10 μm or less. Examples of such short-wavelength radiation include deep ultraviolet rays (e.g., mercury line spectrum and excimer laser light), X-rays, electron beams, and the like. In particular, technology that utilizes KrF excimer laser light (wavelength: 248 nm) or ArF excimer laser light (wavelength: 193 nm) has attracted attention.

As a resist that is suitable for exposure to excimer laser light, various resists (chemically-amplified resists) that utilize a chemical amplification effect due to an acid-dissociable functional group-containing component and a component that generates an acid upon irradiation (exposure) (hereinafter referred to as “acid generator”) have been proposed. For example, a chemically-amplified resist that includes a resin containing a t-butyl ester group of a carboxylic acid or a t-butyl carbonate group of phenol, and an acid generator has been proposed. This resist utilizes a phenomenon in which the t-butyl ester group or the t-butyl carbonate group contained in the resin dissociates due to an acid generated upon exposure to form an acidic group (e.g., carboxyl group or phenolic hydroxyl group), so that the exposed area of the resist film becomes readily soluble in an alkaline developer.

Such a lithographic process will be required to form a more minute pattern (e.g., a resist pattern with a line width of about 90 nm). A pattern with a line width of less than 90 nm may be formed by reducing the wavelength of the light source of the exposure system or increasing the numerical aperture (NA) of the lens. However, an expensive exposure system is required to reduce the wavelength of the light source. When increasing the numerical aperture (NA) of the lens, since the resolution and the depth of focus have a trade-off relationship, a decrease in depth of focus occurs when increasing the resolution.

In recent years, liquid immersion lithography has been proposed as lithographic technology that can solve the above problems. In liquid immersion lithography, a liquid refractive medium (immersion liquid) such as pure water or a fluorine-containing inert liquid is provided on at least the resist film between the lens and the resist film formed on the substrate during exposure. According to liquid immersion lithography, the optical space (path) is filled with a liquid (e.g., pure water) having a high refractive index (n) instead of an inert gas (e.g., air or nitrogen) so that the resolution can be increased without causing a decrease in depth of focus in the same manner as in the case of using a short-wavelength light source or a high NA lens. Since a resist pattern that exhibits high resolution and an excellent depth of focus can be inexpensively formed by liquid immersion lithography using a lens provided in an existing system, liquid immersion lithography has attracted attention.

However, liquid immersion lithography has a problem in which the acid generator or the like is eluted from the resist film since the resist film directly comes in contact with the immersion liquid (e.g., water) during exposure. If elution occurs to a large extent, the lens may be damaged, or the desired pattern shape or sufficient resolution may not be obtained.

When using water as the immersion liquid, if the receding contact angle formed by the resist film and water is low, the immersion liquid may drip from the edge of the wafer during high-speed scanning exposure, or development defects such as a watermark defect (i.e., a watermark remains) or a blob defect (i.e., the solubility of the resist film decreases due to water permeation so that the pattern locally remains unresolved (i.e., an excellent pattern shape is not obtained)) may occur.

Patent Documents 1 and 2 disclose a resin used to form a resist for a liquid immersion lithography system, and Patent Document 3 discloses an additive for such a resist, for example.

However, the receding contact angle formed by the resist and water is not necessarily sufficient even when using a resist that utilizes such a resin or additive. If the receding contact angle is low, the immersion liquid (e.g., water) may drip from the edge of the wafer during high-speed scanning exposure, or development defects such as a watermark defect may occur. Moreover, elution of the acid generator or the like into water mat not be necessarily sufficiently suppressed.
Patent Document 1: WO2004/068242
Patent Document 2: Japanese Patent Application Publication (KOKAI) No. 2005-173474
Patent Document 3: Japanese Patent Application Publication (KOKAI) No. 2005-48029

### DISCLOSURE OF THE INVENTION

### Problems to be Solved by the invention

An object of the present invention is to provide a radiation-sensitive resin composition for liquid immersion lithography that produces an excellent pattern shape, reduces the amount of elution into an immersion liquid (e.g., water) upon contact during exposure, ensures that a high receding contact angle is formed by a resist film and an immersion liquid (e.g., water), and rarely causes development defects, and a novel polymer used for the radiation-sensitive resin composition.

Note that the term “receding contact angle” used herein refers to the contact angle formed by a liquid surface and a substrate when dripping 25 μl of water onto a substrate on which a film is formed, and sucking the water on the substrate at a rate of 10 μl/min. The receding contact angle may be measured using a system “DSA-10” (manufactured by KRUS) (see the examples).

### Means for Solving the Problems

The present invention provides the following.
[1] A radiation-sensitive resin composition including (A) a polymer, (B) an acid-labile group-containing resin, (C) a radiation-sensitive acid generator, and (D) a solvent, the polymer (A) including a repeating unit shown by a following general formula (1) and a repeating unit shown by a following general formula (2),

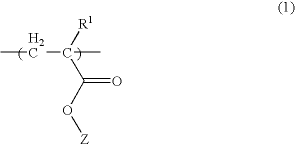

wherein R¹ represents a hydrogen atom, a methyl group, or a trifluoromethyl group, and Z represents a group that includes a structure that generates an acid upon exposure to light,

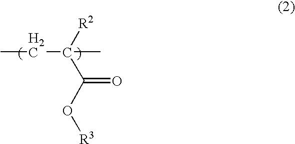

wherein R² represents a hydrogen atom, a methyl group, or a trifluoromethyl group, and R³ represents a linear or branched alkyl group having 1 to 6 carbon atoms in which at least one hydrogen atom is substituted with a fluorine atom, an alicyclic hydrocarbon group having 4 to 20 carbon atoms in which at least one hydrogen atom is substituted with a fluorine atom, or a derivative thereof.
[2] The radiation-sensitive resin composition according to [1], wherein the repeating unit shown by the general formula (1) is at least one of a repeating unit shown by a following general formula (1-1) and a repeating unit shown by a following general formula (1-2),

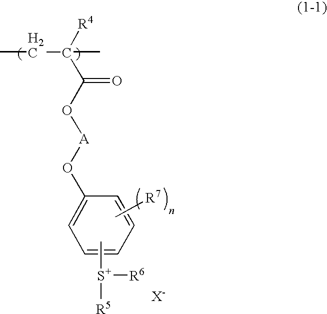

wherein R⁴ represents a hydrogen atom, a methyl group, or a trifluoromethyl group, R⁵, R⁶, and R⁷ individually represent a substituted or unsubstituted linear or branched alkyl group having 1 to 10 carbon atoms, a substituted or unsubstituted linear or branched alkoxy group having 1 to 10 carbon atoms, or a substituted or unsubstituted aryl group having 3 to 10 carbon atoms, n represents an integer from 0 to 3, A represents a methylene group, a linear or branched alkylene group having 2 to 10 carbon atoms, or an arylene group having 3 to 10 carbon atoms, and X⁻ represents a counter ion of S⁺,

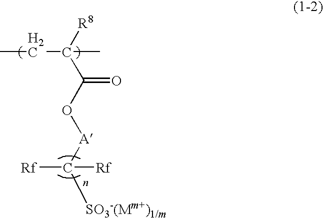

wherein R⁸ represents a hydrogen atom, a methyl group, or a trifluoromethyl group, Rf represents a fluorine atom or a linear or branched perfluoroalkyl group having 1 to 10 carbon atoms, A′ represents a single bond or a divalent organic group, M^{m+} represents a metal ion or an onium cation, m represents an integer from 1 to 3, and n represents an integer from 1 to 8.
[3] The radiation-sensitive resin composition according to [1] or [2], wherein the polymer (A) further includes a repeating unit shown by a following general formula (3),

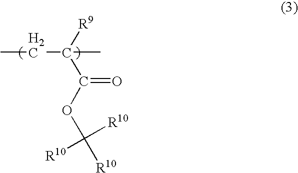

wherein R⁹ represents a hydrogen atom, a methyl group, or a trifluoromethyl group, and R¹⁰ individually represent a monovalent alicyclic hydrocarbon group having 4 to 20 carbon atoms, a derivative thereof, or a linear or branched alkyl group having 1 to 4 carbon atoms, provided that two of R¹⁰ may bond to form a divalent alicyclic hydrocarbon group having 4 to 20 carbon atoms or a derivative thereof together with the carbon atom that is bonded to the two R¹⁰.
[4] The radiation-sensitive resin composition according to any one of [1] to [3], wherein the content of the polymer (A) is 1 to 30 mass % based on 100 mass % of the radiation-sensitive resin composition.
[5] A polymer including a repeating unit shown by a following general formula (1) and a repeating unit shown by a following general formula (2),

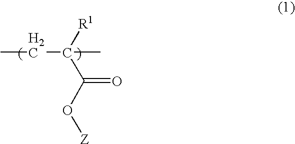

wherein R¹ represents a hydrogen atom, a methyl group, or a trifluoromethyl group, and Z represents a group that includes a structure that generates an acid upon exposure to light,

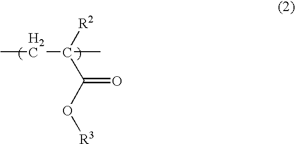

wherein R² represents a hydrogen atom, a methyl group, or a trifluoromethyl group, and R³ represents a linear or branched alkyl group having 1 to 6 carbon atoms in which at least one hydrogen atom is substituted with a fluorine atom, an alicyclic hydrocarbon group having 4 to 20 carbon atoms in which at least one hydrogen atom is substituted with a fluorine atom, or a derivative thereof.
[6] The polymer according to [5], wherein the repeating unit shown by the general formula (1) is at least one of a repeating unit shown by a following general formula (1-1) and a repeating unit shown by a following general formula (1-2),

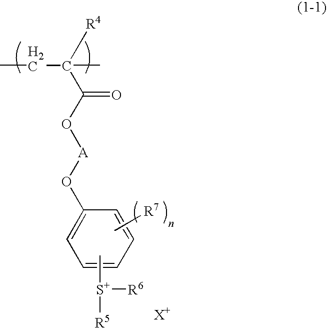

wherein R⁴ represents a hydrogen atom, a methyl group, or a trifluoromethyl group, R⁵, R⁶, and R⁷ individually represent a substituted or unsubstituted linear or branched alkyl group having 1 to 10 carbon atoms, a substituted or unsubstituted linear or branched alkoxy group having 1 to 10 carbon atoms, or a substituted or unsubstituted aryl group having 3 to 10 carbon atoms, n represents an integer from 0 to 3, A represents a methylene group, a linear or branched alkylene group having 2 to 10 carbon atoms, or an arylene group having 3 to 10 carbon atoms, and X⁻ represents a counter ion of S⁺,

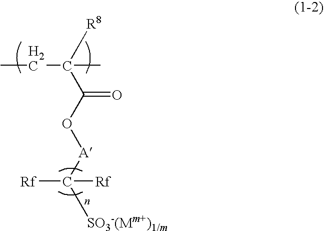

wherein R⁸ represents a hydrogen atom, a methyl group, or a trifluoromethyl group, Rf represents a fluorine atom or a linear or branched perfluoroalkyl group having 1 to 10 carbon atoms, A′ represents a single bond or a divalent organic group, M^{m+} represents a metal ion or an onium cation, m represents an integer from 1 to 3, and n represents an integer from 1 to 8.
[7] The polymer according to [5] or [6], further including a repeating unit shown by a following general formula (3),

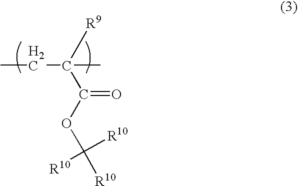

wherein R⁹ represents a hydrogen atom, a methyl group, or a trifluoromethyl group, and R¹⁰ individually represent a monovalent alicyclic hydrocarbon group having 4 to 20 carbon atoms, a derivative thereof, or a linear or branched alkyl group having 1 to 4 carbon atoms, provided that two of R¹⁰ may bond to form a divalent alicyclic hydrocarbon group having 4 to 20 carbon atoms or a derivative thereof together with the carbon atom that is bonded to the two R¹⁰.

### Effects of the Invention

The radiation-sensitive resin composition according to the present invention that includes the above polymer produces an excellent pattern shape, and reduces the amount of elution into an immersion liquid (e.g., water) upon contact during liquid immersion lithography. Moreover, the receding contact angle formed by the resulting resist film and the immersion liquid can be sufficiently increased, and occurrence of development defects can be suppressed.

### BRIEF DESCRIPTION OF THE DRAWINGS

FIG. 1 is a view schematically showing a state in which an 8-inch silicon wafer is placed on a silicone rubber sheet so that leakage of ultrapure water does not occur when measuring the amount of elution from a film formed using a radiation-sensitive resin composition.

FIG. 2 is a cross-sectional view showing a state when measuring the amount of elution from a film formed using a radiation-sensitive resin composition.

### EXPLANATION OF SYMBOLS

1: silicon wafer, 11: hexamethyldisilazane-treated layer, 2: silicone rubber sheet, 3: ultrapure water, 4: silicon wafer, 41: antireflective film, 42: resist film

### BEST MODE FOR CARRYING OUT THE INVENTION

The present invention is described in detail below. Note that the term “(meth)acryl” refers to one or both of “acryl” and “methacryl”.

A radiation-sensitive resin composition according to the present invention includes (A) a polymer, (B) an acid-labile group-containing resin, (C) a radiation-sensitive acid generator, and (D) a solvent. The resin composition may be suitably used to form a resist film that is used for a resist pattern formation method that includes liquid immersion lithography that applies radiation through an immersion liquid (e.g., water) that has a refractive index higher than that of air at a wavelength of 193 nm and is provided between a lens and a resist film.

### <Polymer (A)>

The polymer (A) includes a repeating unit shown by the following general formula (1) (hereinafter may be referred to as “repeating unit (1)”).

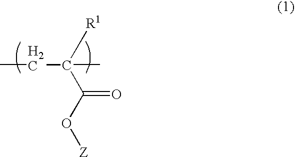

wherein R¹ represents a hydrogen atom, a methyl group, or a trifluoromethyl group, and Z represents a group that includes a structure that generates an acid upon exposure to light.

Z in the general formula (1) represents a group that includes a structure that generates an acid upon exposure to light. Specific examples of the group represented by Z include a group that includes an onium salt, a group that includes halogen, a group that includes a diazoketone structure, a group that includes a sulfone structure, a group that includes a sulfonic acid structure, and the like.

The repeating unit (1) is preferably at least one of a repeating unit shown by the following general formula (1-1) (hereinafter may be referred to as “repeating unit (1-1)”) and a repeating unit shown by the following general formula (1-2) (hereinafter may be referred to as “repeating unit (1-2)”).

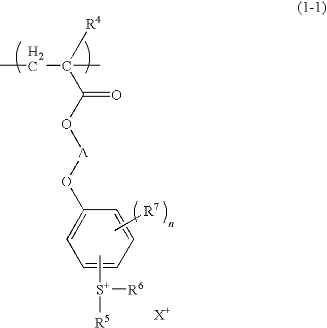

wherein R⁴ represents a hydrogen atom, a methyl group, or a trifluoromethyl group, R⁵, R⁶, and R⁷ individually represent a substituted or unsubstituted linear or branched alkyl group having 1 to 10 carbon atoms, a substituted or unsubstituted linear or branched alkoxy group having 1 to 10 carbon atoms, or a substituted or unsubstituted aryl group having 3 to 10 carbon atoms, n represents an integer from 0 to 3, A represents a methylene group, a linear or branched alkylene group having 2 to 10 carbon atoms, or an arylene group having 3 to 10 carbon atoms, and X⁻ represents a counter ion of S⁺.

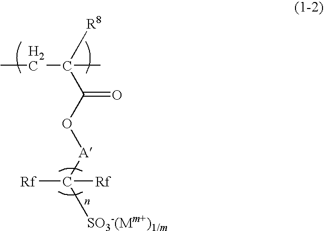

wherein R⁸ represents a hydrogen atom, a methyl group, or a trifluoromethyl group, Rf represents a fluorine atom or a linear or branched perfluoroalkyl group having 1 to 10 carbon atoms, A′ represents a single bond or a divalent organic group, M^{m+} represents a metal ion or an onium cation, m represents an integer from 1 to 3, and n represents an integer from 1 to 8.

Examples of the substituted or unsubstituted linear or branched alkyl group having 1 to 10 carbon atoms represented by R⁵, R⁶, and R⁷ in the general formula (1-1) include a methyl group, an ethyl group, an n-propyl group, an i-propyl group, an n-butyl group, a 2-methylpropyl group, a 1-methylpropyl group, a t-butyl group, a pentyl group, a hexyl group, a hydroxymethyl group, a hydroxyethyl group, and a trifluoromethyl group. The alkyl group may be substituted with a halogen atom or the like. Specifically, the alkyl group may be a haloalkyl group.

Examples of the substituted or unsubstituted linear or branched alkoxy group having 1 to 10 carbon atoms represented by R⁵, R⁶, and R⁷ include a methoxy group, an ethoxy group, an n-propoxy group, an i-propoxy group, an n-butoxy group, a 2-methylpropoxy group, a 1-methylpropoxy group, a t-butoxy group, an n-pentyloxy group, a neopentyloxy group, an n-hexyloxy group, an n-heptyloxy group, an n-octyloxy group, a 2-ethylhexyloxy group, an n-nonyloxy group, an n-decyloxy group, and the like. The alkoxy group may be substituted with a halogen atom or the like.

Examples of the substituted or unsubstituted aryl group having 3 to 10 carbon atoms represented by R⁵, R⁶, and R⁷ include a phenyl group, a naphthyl group, and the like. The aryl group may be substituted with a halogen atom or the like.

R⁵ and R⁶ in the general formula (1-1) are preferably a phenyl group or a naphtyl group among the above monovalent organic groups (alkyl group, alkoxy group, and aryl group), since the resulting compound exhibits excellent stability.

R⁷ in the general formula (1-1) is preferably the alkoxy group (e.g., methoxy group) among the above monovalent organic groups. n in the general formula (1-1) is preferably 0.

A in the general formula (1-1) is a divalent organic group (methylene group, alkylene group, or arylene group) having 10 or less carbon atoms. If the number of carbon atoms of the divalent organic group exceeds 10, sufficient etching resistance may not be obtained.

Examples of the linear or branched alkylene group having 2 to 10 carbon atoms represented by A include an ethylene group, a propylene group (e.g., 1,3-propylene group or 1,2-propylene group), a tetramethylene group, a pentamethylene group, a hexamethylene group, a heptamethylene group, an octamethylene group, a nonamethylene group, a decamethylene group, a 1-methyl-1,3-propylene group, a 2-methyl-1,3-propylene group, a 2-methyl-1,2-propylene group, a 1-methyl-1,4-butylene group, a 2-methyl-1,4-butylene group, and the like. Examples of the arylene group include a phenylene group, a naphthylene group, an anthrylene group, a phenanthrylene group, and the like. Among these, an ethylene group, a propylene group, and the like are preferable since the resulting compound exhibits excellent stability.

Examples of the arylene group having 3 to 10 carbon atoms represented by A include a phenylene group, a naphthylene group, and the like.

X⁻ in the general formula (1-1) represents a counter ion of S⁺. Examples of the counter ion represented by X⁻ include a sulfonate ion, a carboxylate ion, a halogen ion, a BF⁴⁻ ion, a PF⁶⁻ ion, a tetraarylboronium ion, and the like.

The sulfonate ion and the carboxylate ion preferably include an alkyl group, an aryl group, an aralkyl group, an alicyclic alkyl group, a halogen-substituted alkyl group, a halogen-substituted aryl group, a halogen-substituted aralkyl group, an oxygen-substituted alicyclic alkyl group, or a halogen-substituted alicyclic alkyl group. A fluorine atom is preferable as the halogen substituent.

A chloride ion and a bromide ion are preferable as the halogen ion.

A BPh⁴⁻ ion and a B[C₆H₄(CF₃)₂]⁴⁻ ion are preferable as the tetraarylboronium ion.

Examples of a preferable monomer that produces the repeating unit (1-1) include a compound shown by the following formula (1-1-1) and the like.

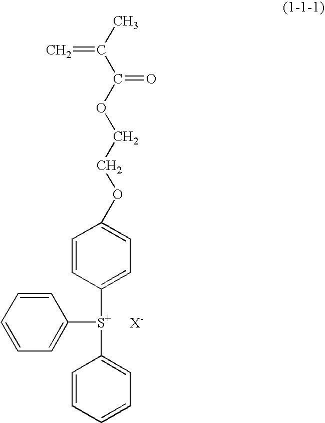

Specific examples of X⁻ in the formula (1-1-1) include ions shown by the following formulas (1a-1) to (1a-26) and the like.

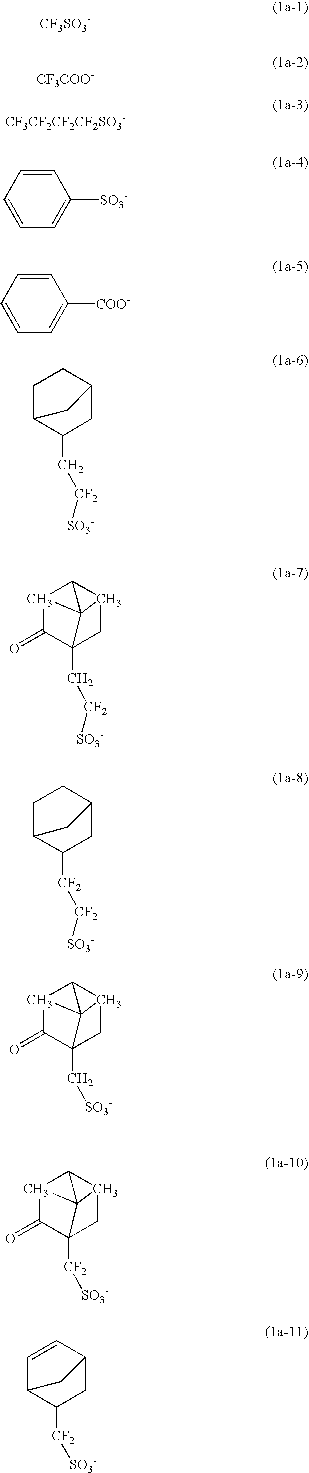

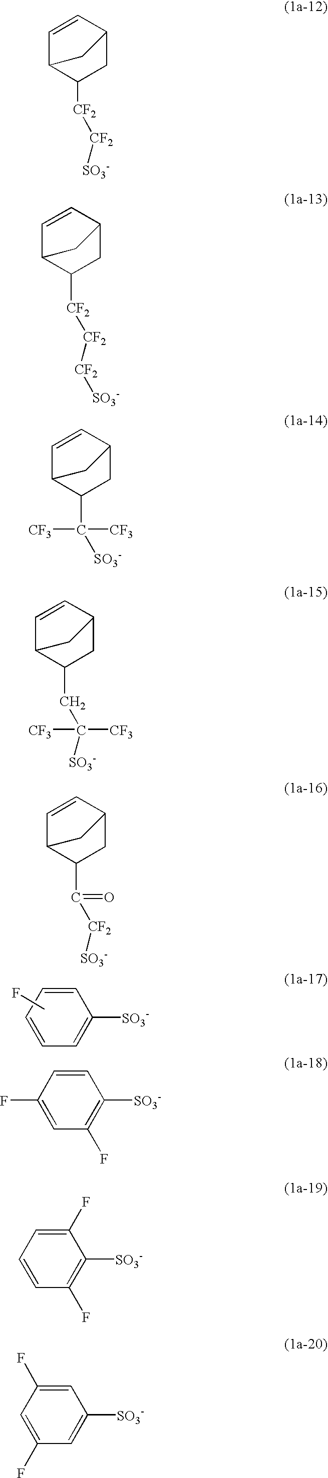

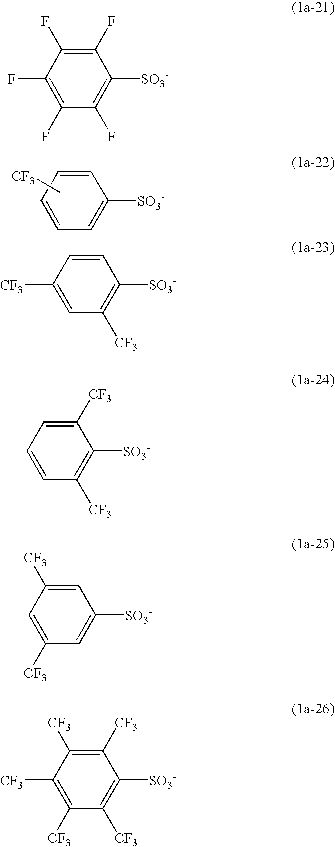

Examples of the linear or branched perfluoroalkyl group having 1 to 10 carbon atoms represented by Rf in the general formula (1-2) include linear perfluoroalkyl groups such as a trifluoromethyl group, a pentafluoroethyl group, a heptafluoropropyl group, a nonafluorobutyl group, an undecafluoropentyl group, a tridecafluorohexyl group, a pentadecafluoroheptyl group, a heptadecafluorooctyl group, a nonadecafluorononyl group, and a heneicosadecyl group, branched perfluoroalkyl groups such as a (1-trifluoromethyl)tetrafluoroethyl group, a (1-trifluoromethyl)hexafluoropropyl group, and a 1,1-bistrifluoromethyl-2,2,2-trifluoroethyl group, and the like.

Rf is preferably a fluorine atom or a trifluoromethyl group in order to achieve excellent resolution.

Note that the two Rf in the general formula (1-2) may be the same or different.

n in the general formula (1-2) is an integer from 1 to 8, and preferably 1 or 2.

Examples of the divalent organic group represented by A′ in the general formula (1-2) include a divalent hydrocarbon group, a —CO— group, an —SO₂— group, and the like.

Examples of the divalent hydrocarbon group include linear or cyclic hydrocarbon groups. Preferable examples of the linear or cyclic hydrocarbon groups include saturated chain-like hydrocarbon groups such as a methylene group, an ethylene group, a propylene group (e.g., 1,3-propylene group or 1,2-propylene group), a tetramethylene group, a pentamethylene group, a hexamethylene group, a heptamethylene group, an octamethylene group, a nonamethylene group, a decamethylene group, an undecamethylene group, a dodecamethylene group, a tridecamethylene group, a tetradecamethylene group, a pentadecamethylene group, a hexadecamethylene group, a heptadecamethylene group, an octadecamethylene group, a nonadecamethylene group, an icosylene group, a 1-methyl-1,3-propylene group, a 2-methyl-1,3-propylene group, a 2-methyl-1,2-propylene group, a 1-methyl-1,4-butylene group, a 2-methyl-1,4-butylene group, a methylidene group, an ethylidene group, a propylidene group, and a 2-propylidene group, monocyclic hydrocarbon groups such as a cycloalkylene group having 3 to 10 carbon atoms, such as a cyclobutylene group (e.g., 1,3-cyclobutylene group), a cyclopentylene group (e.g., 1,3-cyclopentylene group), a cyclohexylene group (e.g., 1,4-cyclohexylene group), and a cyclooctylene group (e.g., 1,5-cyclooctylene group), crosslinked cyclic hydrocarbon groups such as a dicyclic, tricyclic, or tetracyclic hydrocarbon group having 4 to 30 carbon atoms, such as a norbornylene group (e.g., 1,4-norbornylene group or 2,5-norbornylene group) and an admantylene group (e.g., 1,5-admantylene group or 2,6-admantylene group), and the like.

A is preferably a single bond, a —CO— group, a methylene group, an ethylene group, or a norbornylene group.

Examples of the metal ion represented by M^{m+} in the general formula (1-2) include alkali metal ions such as a sodium ion, a potassium ion, and a lithium ion, alkaline earth metal ions such as a magnesium ion and a calcium ion, an iron ion, an aluminum ion, and the like. Among these, a sodium ion, a potassium ion, and a lithium ion are preferable in order to facilitate a sulfonate ion-exchange reaction.

Examples of the onium cation represented by M^{m+} include a sulfonium cation, an iodonium cation, a phosphonium cation, a diazonium cation, an ammonium cation, a pyridinium cation, and the like. Among these, a sulfonium cation shown by the following formula (2a) and an iodonium cation shown by the following formula (2b) are preferable.

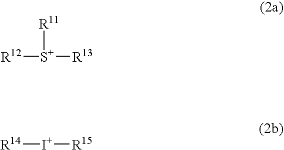

wherein R¹¹, R¹², and R¹³ individually represent a substituted or unsubstituted alkyl group having 1 to 10 carbon atoms or a substituted or unsubstituted aryl group having 4 to 18 carbon atoms, provided that at least two of R¹¹, R¹², and R¹³ may bond to form a ring with the sulfur atom, and R¹⁴ and R¹⁵ individually represent a substituted or unsubstituted alkyl group having 1 to 10 carbon atoms or a substituted or unsubstituted aryl group having 4 to 18 carbon atoms, provided that R¹⁴ and R¹⁵ may bond to form a ring with the iodine atom.

Examples of the substituted or unsubstituted alkyl group having 1 to 10 carbon atoms represented by R¹¹ to R¹⁵ in the general formulas (2a) and (2b) include linear or branched alkyl groups. Specific examples of the linear or branched alkyl groups include a methyl group, an ethyl group, an n-propyl group, an i-propyl group, an n-butyl group, a 1-methylpropyl group, a 2-methylpropyl group, a t-butyl group, an n-pentyl group, an i-pentyl group, a 1,1-dimethylpropyl group, a 1-methylbutyl group, an n-hexyl group, an i-hexyl group, a 1,1-dimethylbutyl group, an n-heptyl group, an n-octyl group, an i-octyl group, a 2-ethylhexyl group, an n-nonyl group, an n-decyl group, and the like.

Examples of the substituted linear or branched alkyl group having 1 to 10 carbon atoms represented by R¹¹ to R¹⁵ include an alkyl group obtained by substituting at least one hydrogen atom of the unsubstituted alkyl group with an aryl group, a linear, branched, or cyclic alkenyl group, a group that includes a heteroatom (e.g., halogen atom, oxygen atom, nitrogen atom, sulfur atom, phosphorus atom, or silicon atom), or the like. Specific examples of such a group include a benzyl group, a methoxymethyl group, a methylthiomethyl group, an ethoxymethyl group, an ethylthiomethyl group, a phenoxymethyl group, a methoxycarbonylmethyl group, an ethoxycarbonylmethyl group, an acetylmethyl group, a fluoromethyl group, a trifluoromethyl group, a chloromethyl group, a trichloromethyl group, a 2-fluoropropyl group, a (trifluoroacetyl)methyl group, a (trichloroacetyl)methyl group, a (pentafluorobenzoyl)methyl group, an aminomethyl group, a (cyclohexylamino)methyl group, a (trimethylsilyl)methyl group, a 2-phenylethyl group, a 2-aminoethyl group, a 3-phenylpropyl group, and the like.

Examples of the unsubstituted aryl group having 4 to 18 carbon atoms represented by R¹¹ to R¹⁵ in the general formulas (2a) and (2b) include a phenyl group, a 1-naphthyl group, a 2-naphthyl group, a 1-anthryl group, a 1-phenanthryl group, a furanyl group, a thiophenyl group, and the like.

Examples of the substituted aryl group having 4 to 18 carbon atoms represented by R¹¹ to R¹⁵ include an aryl group obtained by substituting at least one hydrogen atom of the unsubstituted aryl group with a linear, branched, or cyclic alkyl group, a group that includes a heteroatom (e.g., halogen atom, oxygen atom, nitrogen atom, sulfur atom, phosphorus atom, or silicon atom), or the like. Specific examples of such a group include an o-tolyl group, an m-tolyl group, a p-tolyl group, a 4-hydroxyphenyl group, a 4-methoxyphenyl group, a mesityl group, an o-cumenyl group, a 2,3-xylyl group, a 2,4-xylyl group, a 2,5-xylyl group, a 2,6-xylyl group, a 3,4-xylyl group, a 3,5-xylyl group, a 4-fluorophenyl group, a 4-trifluoromethylphenyl group, a 4-chlorophenyl group, a 4-bromophenyl group, a 4-iodophenyl group, and the like.

Examples of a ring formed by at least two of R¹¹, R¹², and R¹³ in the general formula (2a) together with the sulfur atom include five- to seven-membered ring structure and the like.

Examples of a ring formed by R¹⁴ and R¹⁵ in the general formula (2b) together with the iodine atom include five- to seven-membered ring structure and the like.

Preferable examples ((2a-1) to (2a-64)) of the sulfonium cation shown by the general formula (2a) and preferable examples ((2b-1) to (2b-39)) of the iodonium cation shown by the general formula (2b) are given below.

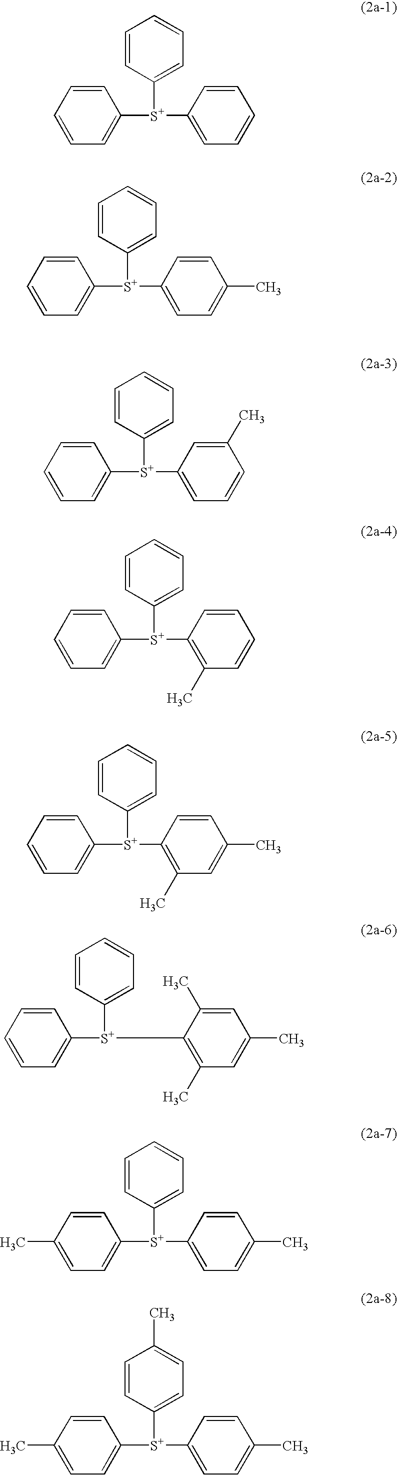

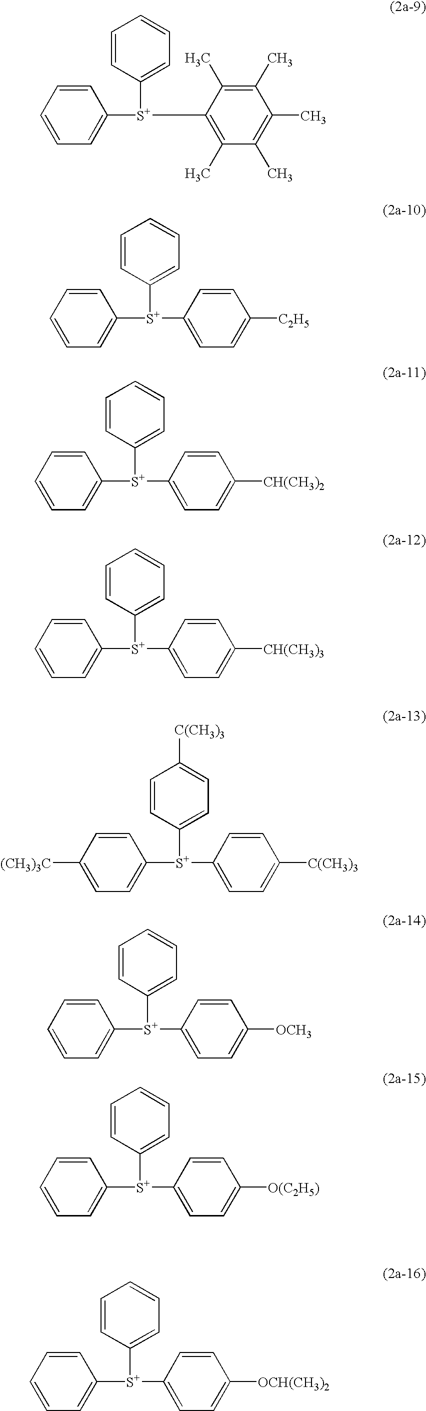

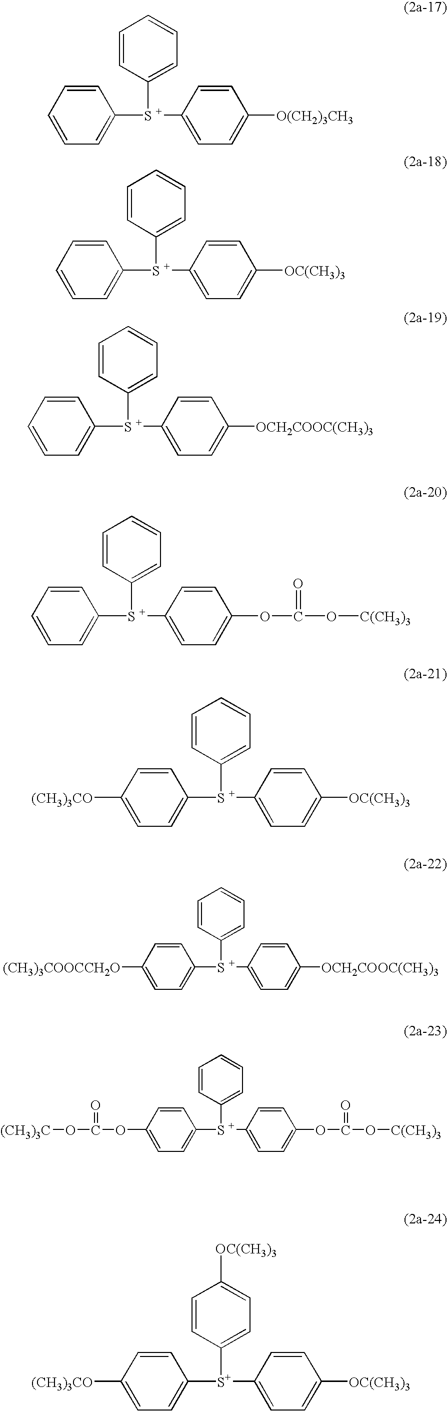

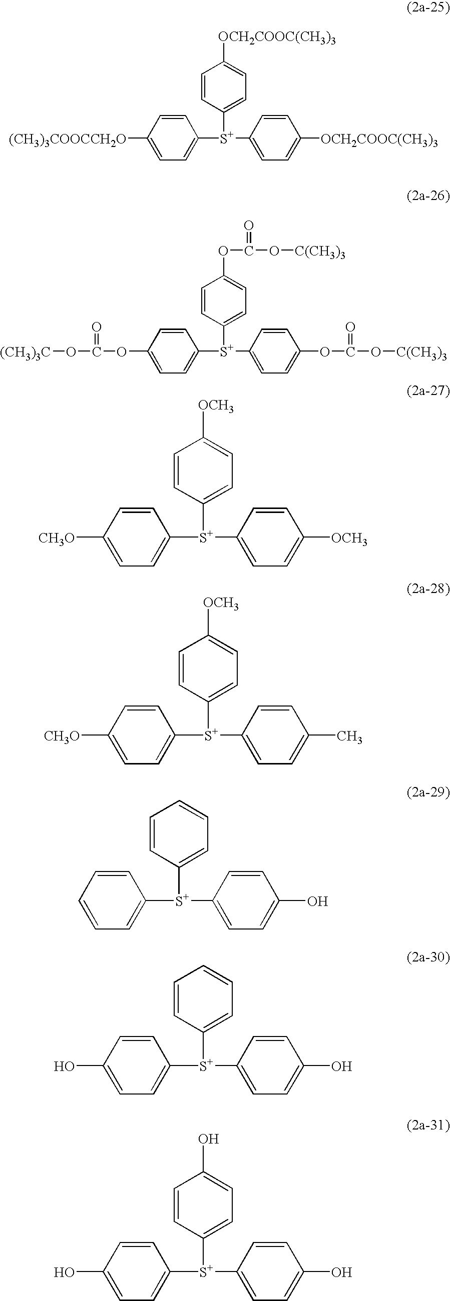

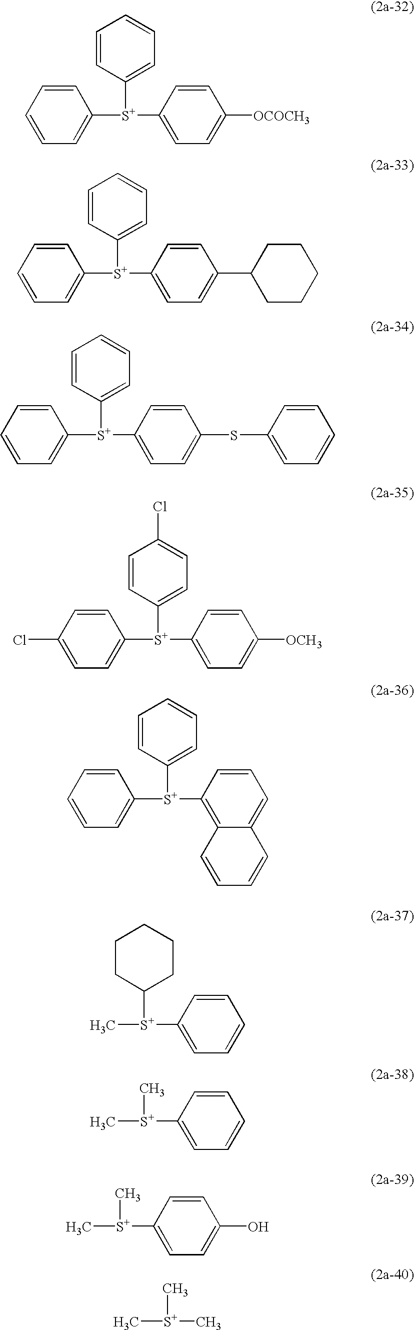

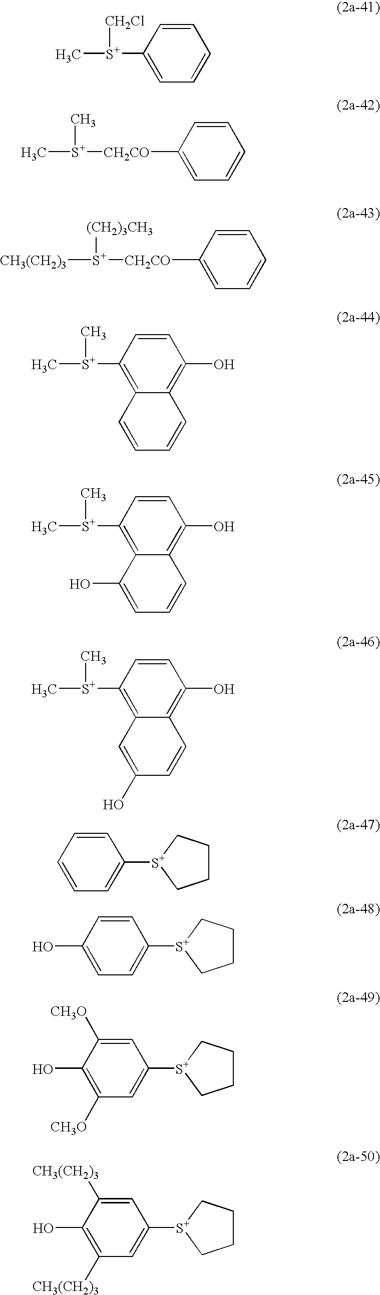

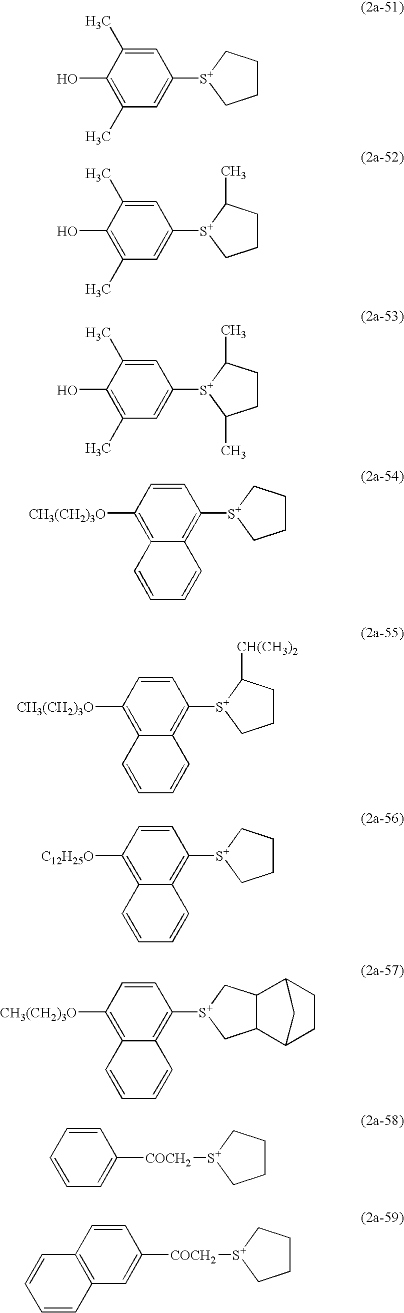

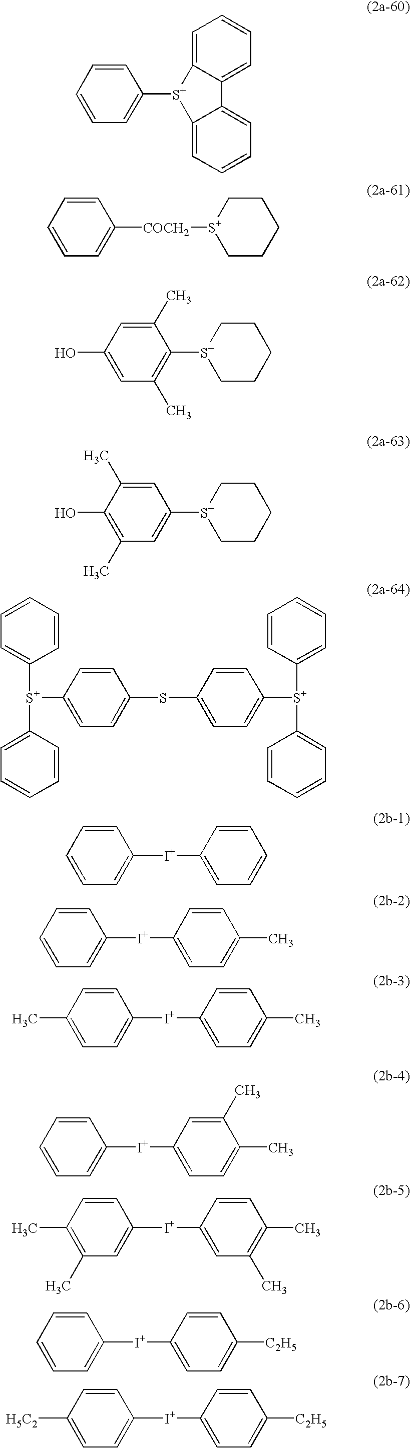

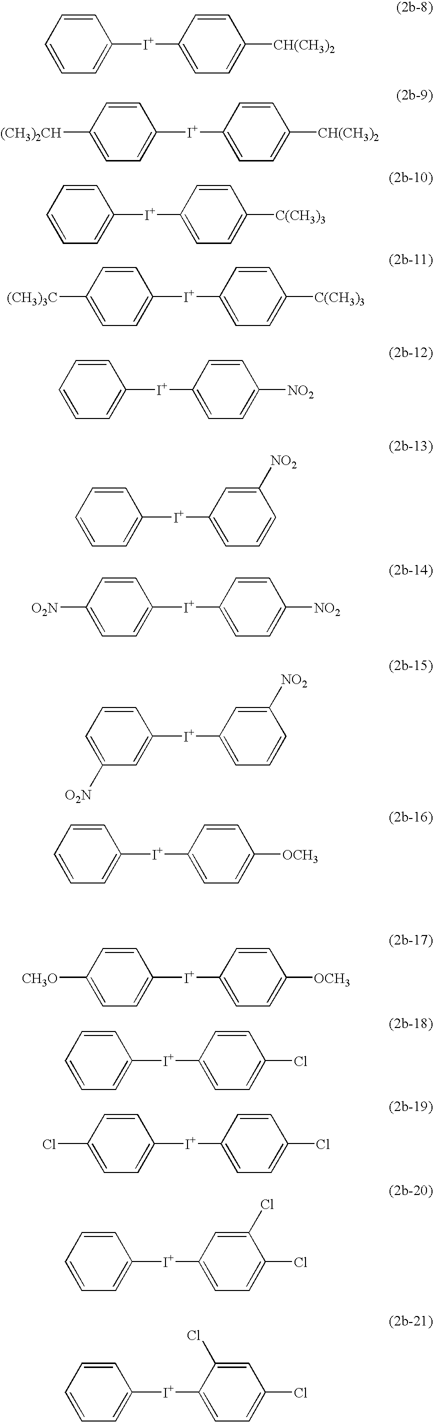

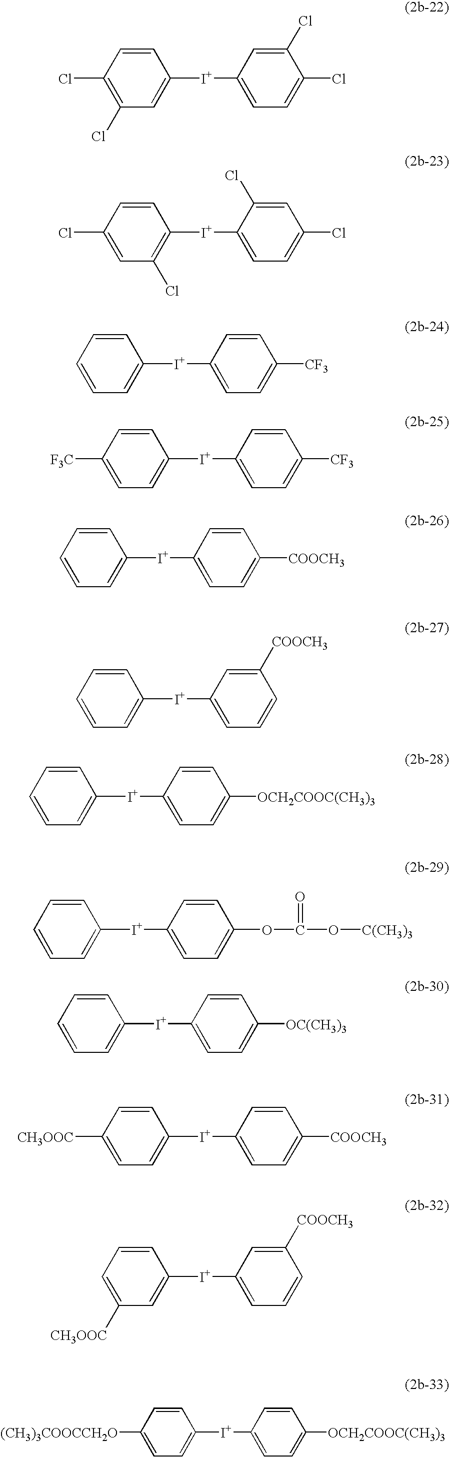

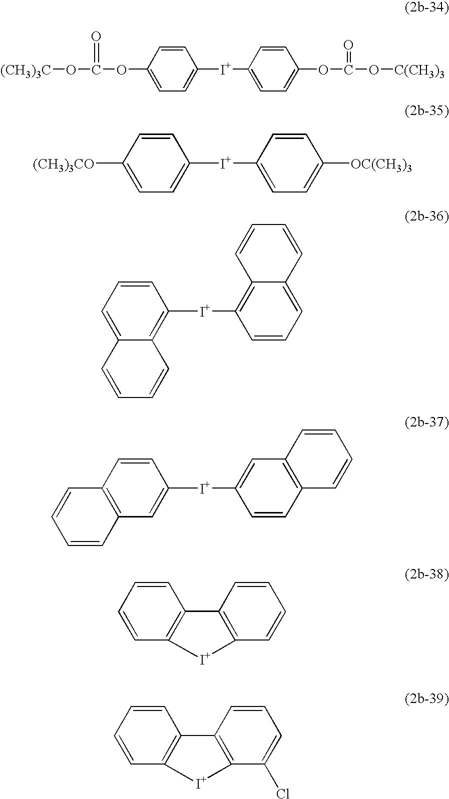

Examples of a preferable monomer that produces the repeating unit (1-2) include compounds shown by the following formulas (1-2-1), (1-2-2), and (1-2-3), and the like.

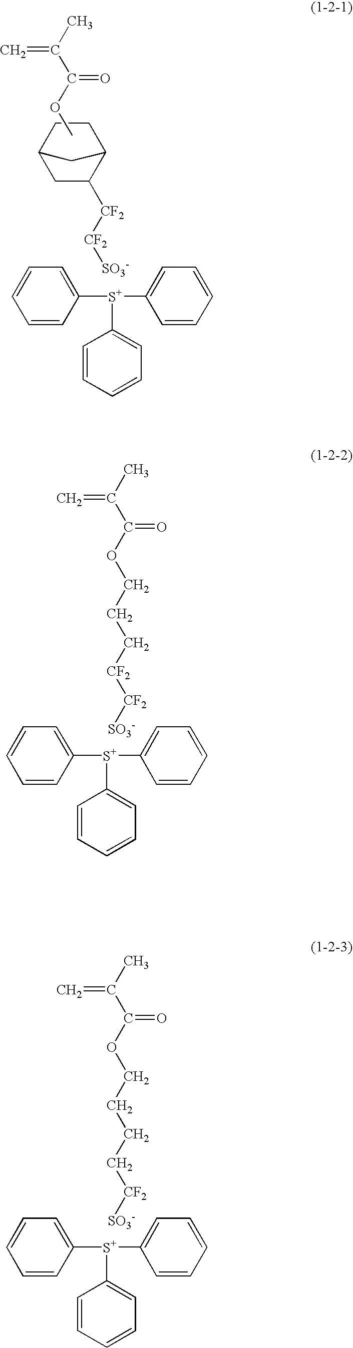

The polymer (A) may include only one type of repeating unit (1), or may include two or more types of repeating units (1).

The polymer (A) also includes a repeating unit shown by the following general formula (2) (hereinafter may be referred to as “repeating unit (2)”).

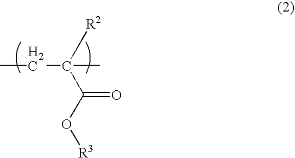

wherein R² represents a hydrogen atom, a methyl group, or a trifluoromethyl group, and R³ represents a linear or branched alkyl group having 1 to 6 carbon atoms in which at least one hydrogen atom is substituted with a fluorine atom, an alicyclic hydrocarbon group having 4 to 20 carbon atoms in which at least one hydrogen atom is substituted with a fluorine atom, or a derivative thereof.

Examples of the linear or branched alkyl group having 1 to 6 carbon atoms in which at least one hydrogen atom is substituted with a fluorine atom that is represented by R³ in the general formula (2) include a partially fluorinated alkyl group, a perfluoroalkyl group, and the like that are derived from an alkyl group such as a methyl group, an ethyl group, a 1-propyl group, a 2-propyl group, a 1-butyl group, a 2-butyl group, a 2-(2-methylpropyl) group, a 1-pentyl group, a 2-pentyl group, a 3-pentyl group, a 1-(2-methylbutyl) group, a 1-(3-methylbutyl) group, a 2-(2-methylbutyl) group, a 2-(3-methylbutyl) group, a neopentyl group, a 1-hexyl group, a 2-hexyl group, a 3-hexyl group, a 1-(2-methylpentyl) group, a 1-(3-methylpentyl) group, a 1-(4-methylpentyl) group, a 2-(2-methylpentyl) group, a 2-(3-methylpentyl) group, a 2-(4-methylpentyl) group, a 3-(2-methylpentyl) group, or a 3-(3-methylpentyl) group.

Examples of the alicyclic hydrocarbon group having 4 to 20 carbon atoms in which at least one hydrogen atom is substituted with a fluorine atom, or a derivative thereof, that is represented by R³ include a partially fluorinated hydrocarbon group, a perfluorohydrocarbon group, and the like that are derived from an alicyclic hydrocarbon group such as a cyclopentyl group, a cyclopentylmethyl group, a 1-(1-cyclopentylethyl) group, a 1-(2-cyclopentylethyl) group, a cyclohexyl group, a cyclohexylmethyl group, a 1-(1-cyclohexylethyl) group, a 1-(2-cyclohexylethyl) group, a cycloheptyl group, a cycloheptylmethyl group, a 1-(1-cycloheptylethyl) group, a 1-(2-cycloheptylethyl) group, or a 2-norbornyl group, or a derivative thereof.

Examples of a preferable monomer that produces the repeating unit (2) include trifluoromethyl(meth)acrylate, 2,2,2-trifluoroethyl(meth)acrylate, perfluoroethyl(meth)acrylate, perfluoro-n-propyl(meth)acrylate, perfluoro-i-propyl(meth)acrylate, perfluoro-n-butyl(meth)acrylate, perfluoro-i-butyl(meth)acrylate, perfluoro t-butyl(meth)acrylate, 2-(1,1,1,3,3,3-hexafluoropropyl)(meth)acrylate, 1-(2,2,3,3,4,4,5,5-octafluoropentyl)(meth)acrylate, perfluorocyclohexylmethyl(meth)acrylate, 1-(2,2,3,3,3-pentafluoropropyl)(meth)acrylate, 1-(3,3,4,4,5,5,6,6,7,7,8,8,9,9,10,10,10-heptadecafluorodecyl)(meth)acrylate, 1-(5-trifluoromethyl-3,3,4,4,5,6,6,6-octafluorohexyl)(meth)acrylate, and the like.

The polymer (A) may include only one type of repeating unit (2), or may include two or more types of repeating units (2).

It is preferable that the polymer (A) further include a repeating unit shown by the following general formula (3) (hereinafter may be referred to as “repeating unit (3)”). If the polymer (A) includes the repeating unit (3), the receding contact angle during exposure can be increased while improving alkali solubility during development. Specifically, since the polymer (A) maintains the structure shown by the general formula (3) during exposure while maintaining the effect of the fluorine-containing repeating units (1) and (2), the receding contact angle can be increased. The —C(R¹⁰)₃ site is then eliminated from the structure shown by the general formula (3) due to an acid so that alkali solubility is improved.

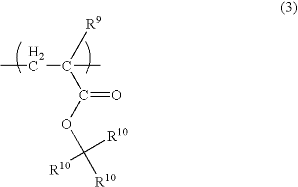

wherein R⁹ represents a hydrogen atom, a methyl group, or a trifluoromethyl group, and R¹⁰ individually represent a monovalent alicyclic hydrocarbon group having 4 to 20 carbon atoms, a derivative thereof, or a linear or branched alkyl group having 1 to 4 carbon atoms, provided that two of R¹⁰ may bond to form a divalent alicyclic hydrocarbon group having 4 to 20 carbon atoms or a derivative thereof together with the carbon atom that is bonded to the two R¹⁰.

Examples of the monovalent alicyclic hydrocarbon group having 4 to 20 carbon atoms represented by R¹⁰ in the general formula (3) include a group that includes an alicyclic ring derived from a cycloalkane such as norbornane, tricyclodecane, tetracyclododecane, adamantane, cyclobutane, cyclopentane, cyclohexane, cycloheptane, or cyclooctane, and the like.

Examples of the derivative of the alicyclic hydrocarbon group include a group obtained by substituting the monovalent alicyclic hydrocarbon group with at least one linear, branched, or cyclic alkyl group having 1 to 4 carbon atoms, such as a methyl group, an ethyl group, an n-propyl group, an i-propyl group, an n-butyl group, a 2-methylpropyl group, a 1-methylpropyl group, or a t-butyl group, and the like.

Among these, an alicyclic hydrocarbon group that includes an alicyclic ring derived from norbornane, tricyclodecane, tetracyclododecane, adamantane, cyclopentane, or cyclohexane, a group obtained by substituting the alicyclic hydrocarbon group with the above alkyl group, and the like are preferable.

Examples of the divalent alicyclic hydrocarbon group having 4 to 20 carbon atoms or a derivative thereof formed by two of R¹⁰ together with the carbon atom that is bonded to the two R¹⁰ (carbon atom bonded to oxygen atom) include a cyclobutyl group, a cyclopentyl group, a cyclohexyl group, a cyclooctyl group, and the like.

Examples of the derivative of the divalent alicyclic hydrocarbon group include a group obtained by substituting the divalent alicyclic hydrocarbon group with at least one linear, branched, or cyclic alkyl group having 1 to 4 carbon atoms, such as a methyl group, an ethyl group, an n-propyl group, an i-propyl group, an n-butyl group, a 2-methylpropyl group, a 1-methylpropyl group, or a t-butyl group, and the like.

Among these, a cyclopentyl group, a cyclohexyl group, a group obtained by substituting a cyclopentyl group or a cyclohexyl group with the above alkyl group, and the like are preferable.

Examples of the linear or branched alkyl group having 1 to 4 carbon atoms represented by R¹⁰ include a methyl group, an ethyl group, an n-propyl group, an i-propyl group, an n-butyl group, a 2-methylpropyl group, a 1-methylpropyl group, a t-butyl group, and the like.

Preferable examples of —C(R¹⁰)₃ in the general formula (3) include a t-butyl group, a 1-n-(1-ethyl-1-methyl)propyl group, a 1-n-(1,1-dimethyl)propyl group, a 1-n-(1,1-dimethyl)butyl group, a 1-n-(1,1-dimethyl)pentyl group, 1-(1,1-diethyl)propyl group, a 1-n-(1,1-diethyl)butyl group, a 1-n-(1,1-diethyl)pentyl group, a 1-(1-methyl)cyclopentyl group, a 1-(1-ethyl)cyclopentyl group, a 1-(1-n-propyl)cyclopentyl group, a 1-(1-i-propyl)cyclopentyl group, a 1-(1-methyl)cyclohexyl group, a 1-(1-ethyl)cyclohexyl group, a 1-(1-n-propyl)cyclohexyl group, a 1-(1-i-propyl)cyclohexyl group, a 1-{1-methyl-1-(2-norbornyl)}ethyl group, a 1-{1-methyl-1-(2-tetracyclodecanyl)}ethyl group, a 1-{1-methyl-1-(1-adamantyl)}ethyl group, a 2-(2-methyl)norbornyl group, a 2-(2-ethyl)norbornyl group, a 2-(2-n-propyl)norbornyl group, a 2-(2-i-propyl)norbornyl group, a 2-(2-methyl)tetracyclodecanyl group, a 2-(2-ethyl)tetracyclodecanyl group, a 2-(2-n-propyl)tetracyclodecanyl group, a 2-(2-i-propyl)tetracyclodecanyl group, a 1-(1-methyl)adamantyl group, a 1-(1-ethyl)adamantyl group, a 1-(1-n-propyl)adamantyl group, a 1-(1-i-propyl)adamantyl group, a group obtained by substituting the above group with at least one linear, branched, or cyclic alkyl group having 1 to 4 carbon atoms, such as a methyl group, an ethyl group, a n-propyl group, an i-propyl group, an n-butyl group, a 2-methylpropyl group, a 1-methylpropyl group, or a t-butyl group, and the like.

The polymer (A) may include only one type of repeating unit (3), or may include two or more types of repeating units (3).

The polymer (A) may include at least one additional repeating unit in addition to the repeating units (1) to (3).

Examples of the additional repeating unit include a repeating unit that includes a lactone skeleton, a hydroxyl group, a carboxyl group, or the like that improves alkali solubility, a repeating unit that includes an aromatic hydrocarbon group or a derivative thereof that suppresses reflection from a substrate, a repeating unit that includes an aromatic hydrocarbon group, a derivative thereof, an alicyclic hydrocarbon group, or a derivative thereof that improves etching resistance, and the like. Among these, a repeating unit that includes a lactone skeleton and a repeating unit that includes an alicyclic hydrocarbon group or a derivative thereof are preferable.

Examples of a preferable monomer that produces the repeating unit that includes a lactone skeleton (hereinafter may be referred to as “repeating unit (4)”) include monomers shown by the following general formulas (4-1) to (4-6), and the like.

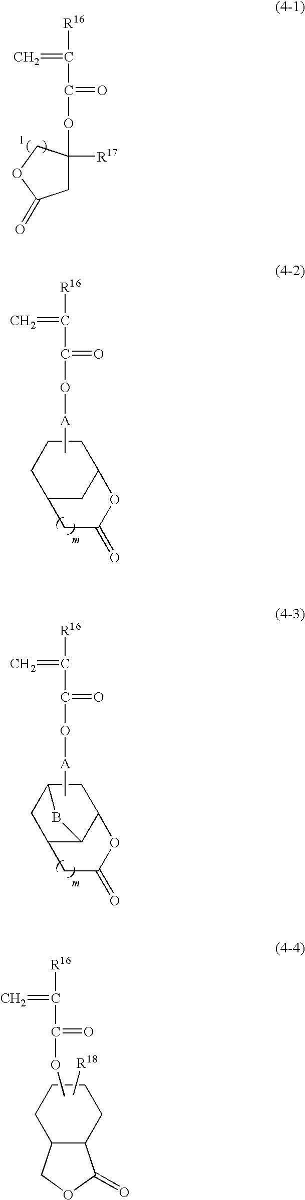

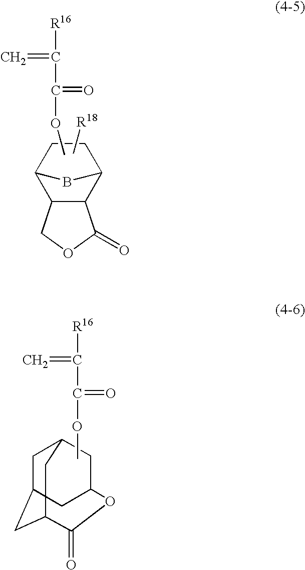

wherein R¹⁶ represents a hydrogen atom or a methyl group, R¹⁷ represents a hydrogen atom or a substituted or unsubstituted alkyl group having 1 to 4 carbon atoms, R¹⁸ represents a hydrogen atom or a methoxy group, A represents a single bond or a methylene group, B represents an oxygen atom or a methylene group, 1 represents an integer from 1 to 3, and m represents 0 or 1.

Specific example of the repeating unit that includes an alicyclic hydrocarbon group or a derivative thereof include a repeating unit shown by the following general formula (5) (hereinafter may be referred to as “repeating unit (5)”).

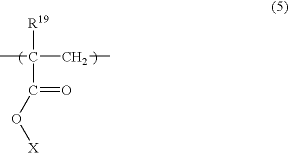

wherein R¹⁹ represents a hydrogen atom, a methyl group, or a trifluoromethyl group, and X represents a substituted or unsubstituted alicyclic hydrocarbon group having 4 to 20 carbon atoms.

Examples of the unsubstituted alicyclic hydrocarbon group having 4 to 20 carbon atoms represented by X in the general formula (5) include a hydrocarbon group that includes an alicyclic ring derived from a cycloalkane such as cyclobutane, cyclopentane, cyclohexane, bicyclo[2.2.1]heptane, bicyclo[2.2.2]octane, tricyclo[5.2.1.0^{2,6}]decane, tetracyclo[6.2.1.1^{3,6}.0^{2,7}]dodecane, or tricycle[3.3.1.1^{3,7}]decane.

Examples of the substituted alicyclic hydrocarbon group having 4 to 20 carbon atoms represented by X include a group obtained by substituting at least one hydrogen atom of the unsubstituted alicyclic hydrocarbon group with at least one of a linear, branched, or cyclic alkyl group having 1 to 4 carbon atoms, such as a methyl group, an ethyl group, an n-propyl group, an i-propyl group, an n-butyl group, a 2-methylpropyl group, a 1-methylpropyl group, or a t-butyl group, a hydroxyl group, a cyano group, a hydroxyalkyl group having 1 to 10 carbon atoms, a carboxyl group, an oxygen atom, and the like.

The content of each repeating unit based on the total content (100 mol %) of the repeating units included in the polymer (A) is preferably as follows.

The content of the repeating unit (1) is preferably 1 to 20 mol %, more preferably 2 to 15 mol %, and still more preferably 3 to 10 mol %. If the content of the repeating unit (1) is less than 1 mol %, the fluororesin layer may not be sufficient deprotected due to acid deficiency. If the content of the repeating unit (1) is more than 20 mol %, a sufficiently high receding contact angle may not be obtained.

The content of the repeating unit (2) is preferably 5 to 50 mol %, more preferably 10 to 40 mol %, and still more preferably 15 to 30 mol %. If the content of the repeating unit (2) is less than 5 mol %, a sufficiently high receding contact angle may not be obtained. If the content of the repeating unit (2) is more than 50 mol %, an excellent pattern shape may not be obtained due to a decrease in solubility of the fluororesin.

The content of the repeating unit (3) is normally 95 mol % or less, preferably 30 to 90 mol %, and more preferably 40 to 85 mol %. If the content of the repeating unit (3) is 95 mol % or less, a sufficiently high receding contact angle can be obtained.

The content of the additional repeating unit is normally 70 mol % or less, and preferably 1 to 65 mol %. If the content of the additional repeating unit is more than 70 mol %, a sufficiently high receding contact angle may not be obtained, or alkali solubility may decrease.

The polymer (A) may be produced by polymerizing polymerizable unsaturated monomers that correspond to the above repeating units in an appropriate solvent optionally in the presence of a chain transfer agent using a radical polymerization initiator such as a hydroperoxide, a dialkyl peroxide, a diacyl peroxide, or an azo compound, for example.

Examples of the solvent used for polymerization include alkanes such as n-pentane, n-hexane, n-heptane, n-octane, n-nonane, and n-decane; cycloalkanes such as cyclohexane, cycloheptane, cyclooctane, decalin, and norbornane; aromatic hydrocarbons such as benzene, toluene, xylene, ethylbenzene, and cumene; halogenated hydrocarbons such as chlorobutanes, bromohexanes, dichloroethanes, hexamethylene dibromide, and chlorobenzene; saturated carboxylates such as ethyl acetate, n-butyl acetate, i-butyl acetate, and methyl propionate; ketones such as acetone, 2-butanone, 4-methyl-2-pentanone, and 2-heptanone; ethers such as tetrahydrofuran, dimethoxyethanes, and diethoxyethanes; alcohols such as methanol, ethanol, 1-propanol, 2-propanol, and 4-methyl-2-pentanol; and the like. These solvents may be used either individually or in combination.

The polymerization temperature is normally 40 to 150° C., and preferably 50 to 120° C. The reaction time is normally 1 to 48 hours, and preferably 1 to 24 hours.

The polystyrene-reduced weight average molecular weight (Mw) of the polymer

(A) determined by gel permeation chromatography (GPC) is preferably 1000 to 50,000, more preferably 1000 to 40,000, and still more preferably 1000 to 30,000. If the Mw of the polymer (A) is less than 1000, a sufficiently high receding contact angle may not be obtained. If the Mw of the polymer (A) is more than 50,000, the developability of the resulting resist may decrease.

The ratio (Mw/Mn) of the Mw to the polystyrene-reduced number average molecular weight (Mn) of the polymer (A) determined by GPC is normally 1 to 5, and preferably 1 to 4.

It is preferable that the content of impurities (e.g., halogen or metal) in the polymer (A) be as low as possible. If the polymer (A) has a low impurity content, the sensitivity, the resolution, the process stability, the pattern shape, and the like of the resulting resist are further improved.

The polymer (A) may be purified by chemical purification (e.g., washing with water or liquid-liquid extraction), or a combination of chemical purification and physical purification (e.g., ultrafiltration or centrifugation), for example.

The radiation-sensitive resin composition may include only one type of polymer (A), or may include two or more of types of polymers (A).

In the present invention, the polymer (A) is used as an additive for a resist. The polymer (A) is normally used in an amount of 0.1 to 40 parts by mass, and preferably 0.5 to 35 parts by mass, based on 100 parts by mass of a resin (B) described later, from the viewpoint of providing the resulting resist with basic performance (e.g., sensitivity, depth of focus, and developability). If the amount of the polymer (A) is less than 0.1 parts by mass, the effect of the polymer (A) may not be obtained so that the receding contact angle of the resulting resist film may decrease. If the amount of the polymer (A) is more than 40 parts by mass, a rectangular resist pattern may not be obtained, or the depth of focus may decrease.

### <Resin (B)>

An acid-labile group-containing resin (B) (hereinafter may be referred to as “resin (B)”) is preferably a resin that is insoluble or scarcely soluble in alkali, but becomes alkali-soluble due to an acid, so that the polymer (A) exerts its effects (i.e., an increase in receding contact angle, a decrease in elution, and suppression of development defects) on the radiation-sensitive resin composition.

The expression “insoluble or scarcely soluble in alkali” means that a film that is formed only of the resin (B) has a thickness equal to or more than 50% of the initial thickness when developed under alkaline development conditions employed when forming a resist pattern using a resist film that is formed of a radiation-sensitive resin composition that includes the resin (B).

Examples of the resin (B) include a resin that includes an alicyclic skeleton such as a norbornane ring in the main chain and is obtained by polymerizing a norbornene derivative or the like, a resin that includes a norbornane ring and a maleic anhydride derivative in the main chain and is obtained by copolymerizing a norbornene derivative and maleic anhydride, a resin that includes a norbornane ring and a (meth)acrylic skeleton in the main chain and is obtained by copolymerizing a norbornene derivative and a (meth)acrylic compound, a resin that includes a norbornane ring, a maleic anhydride derivative, and a (meth)acrylic skeleton in the main chain and is obtained by copolymerizing a norbornene derivative, maleic anhydride, and a (meth)acrylic compound, a resin that includes a (meth)acrylic skeleton in the main chain and is obtained by copolymerizing (meth)acrylic compounds, and the like.

The resin (B) is preferably a resin that includes a (meth)acrylic skeleton in the main chain, and preferably includes at least one repeating unit (4) that includes a lactone skeleton. It is preferable that the resin (B) include at least one repeating unit (3) in addition to the repeating unit (4). The above description applies to preferable monomers that produce the repeating units (3) and (4) included in the resin (B).

The content of each repeating unit based on the total content (100 mol %) of the repeating units included in the resin (B) is preferably as follows.

The content of the repeating unit (4) is preferably 5 to 85 mol %, more preferably 10 to 70 mol %, and still more preferably 15 to 60 mol %. If the content of the repeating unit (4) is less than 5 mol %, developability and the exposure limit margin may deteriorate. If the content of the repeating unit (4) is more than 85 mol %, the solubility and the resolution of the resin may deteriorate.

The content of the repeating unit (3) is preferably 10 to 70 mol %, preferably 15 to 60 mol %, and more preferably 20 to 50 mol %. If the content of the repeating unit (3) is less than 10 mol %, the resolution of the resulting resist may decrease. If the content of the repeating unit (3) is more than 70 mol %, the exposure limit margin may deteriorate.

The resin (B) may be produced by polymerizing polymerizable unsaturated monomers that correspond to the above repeating units in an appropriate solvent optionally in the presence of a chain transfer agent using a radical polymerization initiator such as a hydroperoxide, a dialkyl peroxide, a diacyl peroxide, or an azo compound.

Examples of the solvent used for polymerization include alkanes such as n-pentane, n-hexane, n-heptane, n-octane, n-nonane, and n-decane; cycloalkanes such as cyclohexane, cycloheptane, cyclooctane, decalin, and norbornane; aromatic hydrocarbons such as benzene, toluene, xylene, ethylbenzene, and cumene; halogenated hydrocarbons such as chlorobutanes, bromohexanes, dichloroethanes, hexamethylene dibromide, and chlorobenzene; saturated carboxylates such as ethyl acetate, n-butyl acetate, i-butyl acetate, and methyl propionate; ketones such as acetone, 2-butanone, 4-methyl-2-pentanone, and 2-heptanone; ethers such as tetrahydrofuran, dimethoxyethanes, and diethoxyethanes; and the like. These solvents may be used either individually or in combination.

The polymerization temperature is normally 40 to 150° C., and preferably 50 to 120° C. The reaction time is normally 1 to 48 hours, and preferably 1 to 24 hours.

The Mw of the resin (B) determined by GPC is preferably 1000 to 100,000, more preferably 1000 to 30,000, and still more preferably 1000 to 20,000. If the Mw of the resin (B) is less than 1000, the heat resistance of the resulting resist may decrease. If the Mw of the resin (B) is more than 100,000, the developability of the resulting resist may decrease.

The ratio (Mw/Mn) of the Mw to the Mn of the resin (B) determined by GPC is normally 1 to 5, and preferably 1 to 3.

The content (solid content) of low-molecular-weight components derived from the monomers used to produce the resin (B) is preferably 0.1 mass % or less, more preferably 0.07 mass % or less, and still more preferably 0.05 mass % or less, based on 100 mass % of the resin (B). If the content of low-molecular-weight components is less than 0.1 mass %, the amount of elution into an immersion liquid (e.g., water) during liquid immersion lithography can be reduced. Moreover, it is possible to prevent a situation in which foreign matter is produced in the resist during storage, prevent non-uniform resist application, and sufficiently suppress occurrence of defects during resist pattern formation.

Examples of the low-molecular-weight components derived from the monomers include components (e.g., monomer, dimer, trimer, and oligomer) having an Mw of 500 or less. The components having an Mw of 500 or less may be removed by chemical purification (e.g., washing with water or liquid-liquid extraction) or a combination of chemical purification and physical purification (e.g., ultrafiltration or centrifugation), for example. The content of the components having an Mw of 500 or less may be determined by high-performance liquid chromatography (HPLC).

It is preferable that the content of impurities (e.g., halogen or metal) in the resin (B) be as low as possible. If the resin (B) has a low impurity content, the sensitivity, the resolution, the process stability, the pattern shape, and the like of the resulting resist are further improved.

The resin (B) may be purified by chemical purification (e.g., washing with water or liquid-liquid extraction) or a combination of chemical purification and physical purification (e.g., ultrafiltration or centrifugation), for example.

The radiation-sensitive resin composition may include only one type of resin (B), or may include two or more of types of resins (B).

### <Radiation-Sensitive Acid Generator (C)>

A radiation-sensitive acid generator (C) (hereinafter may be referred to as “acid generator (C)”) used in the present invention is a compound that generates an acid upon exposure, and causes the acid-dissociable group of the repeating unit (3) included in the resin component to dissociate (elimination of protecting group) due to the acid generated upon exposure. As a result, the exposed area of the resist film becomes readily soluble in an alkaline developer so that a positive-tone resist pattern is formed.

The acid generator (C) preferably includes a compound shown by the following general formula (6).

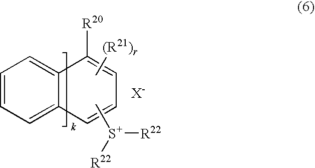

R²⁰ in the general formula (6) represents a hydrogen atom, a fluorine atom, a hydroxyl group, a linear or branched alkyl group having 1 to 10 carbon atoms, a linear or branched alkoxy group having 1 to 10 carbon atoms, or a linear or branched alkoxycarbonyl group having 2 to 11 carbon atoms.

R²¹ represents a linear or branched alkyl group having 1 to 10 carbon atoms, a linear or branched alkoxy group having 1 to 10 carbon atoms, or a linear, branched, or cyclic alkanesulfonyl group having 1 to 10 carbon atoms.

R²² individually represent a linear or branched alkyl group having 1 to 10 carbon atoms, a substituted or unsubstituted phenyl group, or a substituted or unsubstituted naphtyl group, or bond to form a substituted or unsubstituted divalent group having 2 to 10 carbon atoms.

k represents an integer from 0 to 2, X⁻ represents an anion shown by R²³CₙF₂ₙSO₃⁻ (wherein R²³ represents a fluorine atom or a substituted or unsubstituted hydrocarbon group having 1 to 12 carbon atoms, and n represents an integer from 1 to 10), and r represents an integer from 0 to 10.

Examples of the linear or the branched alkyl group having 1 to 10 carbon atoms represented by R²⁰, R²¹, and R²² in the general formula (6) include a methyl group, an ethyl group, an n-propyl group, an i-propyl group, an n-butyl group, a 2-methylpropyl group, a 1-methylpropyl group, a t-butyl group, an n-pentyl group, a neopentyl group, an n-hexyl group, an n-heptyl group, an n-octyl group, a 2-ethylhexyl group, an n-nonyl group, an n-decyl group, and the like. Among these, a methyl group, an ethyl group, an n-butyl group, a t-butyl group, and the like are preferable.

Examples of the linear or branched alkoxy group having 1 to 10 carbon atoms represented by R²⁰ and R²¹ include a methoxy group, an ethoxy group, an n-propoxy group, an i-propoxy group, an n-butoxy group, a 2-methylpropoxy group, a 1-methylpropoxy group, a t-butoxy group, an n-pentyloxy group, a neopentyloxy group, an n-hexyloxy group, an n-heptyloxy group, an n-octyloxy group, a 2-ethylhexyloxy group, an n-nonyloxy group, an n-decyloxy group, and the like. Among these, a methoxy group, an ethoxy group, an n-propoxy group, a t-butoxy group, and the like are preferable.

Examples of the linear or branched alkoxycarbonyl group having 2 to 11 carbon atoms represented by R²⁰ include a methoxycarbonyl group, an ethoxycarbonyl group, an n-propoxycarbonyl group, an i-propoxycarbonyl group, an n-butoxycarbonyl group, a 2-methylpropoxycarbonyl group, an 1-methylpropoxycarbonyl group, a t-butoxycarbonyl group, an n-pentyloxycarbonyl group, a neopentyloxycarbonyl group, an n-hexyloxycarbonyl group, an n-heptyloxycarbonyl group, an n-octyloxycarbonyl group, a 2-ethylhexyloxycarbonyl group, an n-nonyloxycarbonyl group, an n-decyloxycarbonyl group, and the like. Among these, a methoxycarbonyl group, an ethoxycarbonyl group, an n-butoxycarbonyl group, and the like are preferable.

Examples of the linear, branched, or cyclic alkanesulfonyl group having 1 to 10 carbon atoms represented by R²¹ include a methanesulfonyl group, an ethanesulfonyl group, an n-propanesulfonyl group, an n-butanesulfonyl group, a tert-butanesulfonyl group, an n-pentanesulfonyl group, a neopentanesulfonyl group, an n-hexanesulfonyl group, an n-heptanesulfonyl group, an n-octanesulfonyl group, a 2-ethylhexanesulfonyl group, an n-nonanesulfonyl group, an n-decanesulfonyl group, a cyclopentanesulfonyl group, a cyclohexanesulfonyl group, and the like. Among these, a methanesylfonyl group, an ethanesulfonyl group, an n-propanesulfonyl group, an n-butanesulfonyl group, a cyclopentansulfonyl group, a cyclohexanesulfonyl group, and the like are preferable.

r in the general formula (6) is preferably 0 to 2.

Examples of the substituted or unsubstituted phenyl group represented by R²² in the general formula (6) include a phenyl group, a phenyl group substituted with a linear, branched, or cyclic alkyl group having 1 to 10 carbon atoms, such as an o-tolyl group, an m-tolyl group, a p-tolyl group, a 2,3-dimethylphenyl group, a 2,4-dimethylphenyl group, a 2,5-dimethylphenyl group, a 2,6-dimethylphenyl group, a 3,4-dimethylphenyl group, a 3,5-dimethylphenyl group, a 2,4,6-trimethylphenyl group, a 4-ethylphenyl group, a 4-t-butylphenyl group, 4-cyclohexylphenyl group, or a 4-fluorophenyl group; a group obtained by substituting the phenyl group or the alkyl-substituted phenyl group with at least one group such as a hydroxyl group, a carboxyl group, a cyano group, a nitro group, an alkoxy group, an alkoxyalkyl group, an alkoxycarbonyl group, or an alkoxycarbonyloxy group; and the like.

Examples of the alkoxy group as the substituent for the phenyl group or the alkyl-substituted phenyl group include linear, branched, or cyclic alkoxy groups having 1 to 20 carbon atoms, such as a methoxy group, an ethoxy group, an n-propoxy group, an i-propoxy group, an n-butoxy group, a 2-methylpropoxy group, a 1-methylpropoxy group, a t-butoxy group, a cyclopentyloxy group, and a cyclohexyloxy group, and the like.

Examples of the alkoxyalkyl group include linear, branched, or cyclic alkoxyalkyl groups having 2 to 21 carbon atoms, such as a methoxymethyl group, an ethoxymethyl group, a 1-methoxyethyl group, a 2-methoxyethyl group, a 1-ethoxyethyl group, and a 2-ethoxyethyl group, and the like.

Examples of the alkoxycarbonyl group include linear, branched, or cyclic alkoxycarbonyl groups having 2 to 21 carbon atoms, such as a methoxycarbonyl group, an ethoxycarbonyl group, an n-propoxycarbonyl group, an i-propoxycarbonyl group, an n-butoxycarbonyl group, a 2-methylpropoxycarbonyl group, a 1-methylpropoxycarbonyl group, a t-butoxycarbonyl group, a cyclopentyloxycarbonyl group, and a cyclohexyloxycarbonyl group, and the like.

Examples of the alkoxycarbonyloxy group include linear, branched, or cyclic alkoxycarbonyloxy groups having 2 to 21 carbon atoms, such as a methoxycarbonyloxy group, an ethoxycarbonyloxy group, an n-propoxycarbonyloxy group, an i-propoxycarbonyloxy group, an n-butoxycarbonyloxy group, a t-butoxycarbonyloxy group, a cyclopentyloxycarbonyl group, and a cyclohexyloxycarbonyl group, and the like.

Among these substituted or unsubstituted phenyl groups, a phenyl group, a 4-cyclohexylphenyl group, a 4-t-butylphenyl group, a 4-methoxyphenyl group, a 4-t-butoxyphenyl group, and the like are preferable.

Examples of the substituted or unsubstituted naphthyl group represented by R²² include naphthyl groups substituted or unsubstituted with a linear, branched, or cyclic alkyl group having 1 to 10 carbon atoms, such as a 1-naphthyl group, a 2-methyl-1-naphthyl group, a 3-methyl-1-naphthyl group, a 4-methyl-1-naphthyl group, a 4-methyl-1-naphthyl group, a 5-methyl-1-naphthyl group, a 6-methyl-1-naphthyl group, a 7-methyl-1-naphthyl group, a 8-methyl-1-naphthyl group, a 2,3-dimethyl-1-naphthyl group, a 2,4-dimethyl-1-naphthyl group, a 2,5-dimethyl-1-naphthyl group, a 2,6-dimethyl-1-naphthyl group, a 2,7-dimethyl-1-naphthyl group, a 2,8-dimethyl-1-naphthyl group, a 3,4-dimethyl-1-naphthyl group, a 3,5-dimethyl-1-naphthyl group, a 3,6-dimethyl-1-naphthyl group, a 3,7-dimethyl-1-naphthyl group, a 3,8-dimethyl-1-naphthyl group, a 4,5-dimethyl-1-naphthyl group, a 5,8-dimethyl-1-naphthyl group, a 4-ethyl-1-naphthyl group, a 2-naphthyl group, a 1-methyl-2-naphthyl group, a 3-methyl-2-naphthyl group, and a 4-methyl-2-naphthyl group; a group obtained by substituting the naphthyl group or the alkyl-substituted naphthyl group with at least one group such as a hydroxyl group, a carboxyl group, a cyano group, a nitro group, an alkoxyl group, an alkoxyalkyl group, an alkoxycarbonyl group, or an alkoxycarbonyloxy group; and the like.

Examples of the alkoxy group, the alkoxyalkyl group, the alkoxycarbonyl group, and the alkoxycarbonyloxy group as the substituents include the groups mentioned for the phenyl group and the alkyl-substituted phenyl groups.

Among these substituted or unsubstituted naphthyl groups, a 1-naphthyl group, a 1-(4-methoxynaphthyl) group, a 1-(4-ethoxynaphthyl) group, a 1-(4-n-propoxynaphthyl) group, a 1-(4-n-butoxynaphthyl) group, a 2-(7-methoxynaphthyl) group, a 2-(7-ethoxynaphthyl) group, a 2-(7-n-propoxynaphthyl) group, a 2-(7-n-butoxynaphthyl) group, and the like are preferable.

The divalent group having 2 to 10 carbon atoms formed by the two R²² is preferably a group that forms a five- or six-membered ring (particularly preferably a five-membered ring (i.e., tetrahydrothiophene ring)) together with the sulfur atom in the general formula (6).

Examples of the substituent for the above divalent group include the groups mentioned for the phenyl group and the alkyl-substituted phenyl group, such as a hydroxyl group, a carboxyl group, a cyano group, a nitro group, an alkoxy group, an alkoxyalkyl group, an alkoxycarbonyl group, and an alkoxycarbonyloxy group.

It is preferable that R²² in the general formula (6) be a methyl group, an ethyl group, a phenyl group, a 4-methoxyphenyl group, a 1-naphthyl group, or the like, or bond to form a divalent group that forms a tetrahydrothiophene cyclic structure together with the sulfur atom.

The CₙF₂ₙ⁻ group in the R²³CₙF₂ₙSO₃⁻ anion represented by X⁻ in the general formula (6) is a perfluoroalkyl group having n carbon atoms. This group may be either linear or branched. n is preferably 1, 2, 4, or 8.

The substituted or unsubstituted hydrocarbon group having 1 to 12 carbon atoms represented by R²³ is preferably an alkyl group having 1 to 12 carbon atoms, a cycloalkyl group, or a bridged alicyclic hydrocarbon group.

Specific examples of the substituted or unsubstituted hydrocarbon group having 1 to 12 carbon atoms represented by R²³ include a methyl group, an ethyl group, an n-propyl group, an i-propyl group, an n-butyl group, a 2-methylpropyl group, a 1-methylpropyl group, a t-butyl group, an n-pentyl group, an neopentyl group, an n-hexyl group, a cyclohexyl group, an n-heptyl group, an n-octyl group, a 2-ethylhexyl group, an n-nonyl group, an n-decyl group, a norbornyl group, a norbornylmethyl group, a hydroxynorbornyl group, an adamantyl group, and the like.

Specific examples of a preferable compound shown by the general formula (6) include triphenylsulfonium trifluoromethanesulfonate, tri-tert-butylphenylsulfonium trifluoromethanesulfonate, 4-cyclohexylphenyl-diphenylsulfonium trifluoromethanesulfonate, 4-methanesulfonylphenyl-diphenylsulfonium trifluoromethanesulfonate, 1-(3,5-dimethyl 4-hydroxyphenyl)tetrahydrothiophenium trifluoromethanesulfonate, 1-(4-n-butoxynaphthyl)tetrahydrothiophenium trifluoromethanesulfonate, triphenylsulfonium perfluoro-n-butanesulfonate, tri-tert-butylphenylsulfonium perfluoro-n-butanesulfonate, 4-cyclohexylphenyl-diphenylsulfonium perfluoro-n-butanesulfonate, 4-methanesulfonylphenyl-diphenylsulfonium perfluoro-n-butanesulfonate, 1-(3,5-dimethyl-4-hydroxyphenyl)tetrahydrothiophenium perfluoro-n-butanesulfonate, 1-(4-n-butoxynaphthyl)tetrahydrothiophenium perfluoro-n-butanesulfonate, triphenylsulfonium perfluoro-n-octanesulfonate, tri-tert-butylphenylsulfonium perfluoro-n-octanesulfonate, 4-cyclohexylphenyl-diphenylsulfonium perfluoro-n-octanesulfonate, 4-methanesulfonylphenyl-diphenylsulfonium perfluoro-n-octanesulfonate, 1-(3,5-dimethyl-4-hydroxyphenyl)tetrahydrothiophenium perfluoro-n-octanesulfonate, 1-(4-n-butoxynaphthyl)tetrahydrothiophenium perfluoro-n-octanesulfonate, triphenylsulfonium 2-(bicyclo[2.2.1]hept-2′-yl)-1,1,2,2-tetrafluoroethanesulfonate, tri-tert-butylphenylsulfonium 2-(bicyclo[2.2.1]hept-2′-yl)-1,1,2,2-tetrafluoroethanesulfonate, 4-cyclohexylphenyldiphenylsulfonium 2-(bicyclo[2.2.1]hept-2′-yl)-1,1,2,2-tetrafluoroethane sulfonate, 4-methanesulfonylphenyldiphenylsulfonium 2-(bicyclo[2.2.1]hept-2′-yl)-1,1,2,2-tetrafluoroethanesulfonate, 1-(3,5-dimethyl-4-hydroxyphenyl)tetrahydrothiophenium 2-(bicyclo[2.2.1]hept-2′-yl)-1,1,2,2-tetrafluoroethanesulfonate, 1-(4-n-butoxynaphthyl)tetrahydrothiophenium 2-(bicyclo [2.2.1]hept-2′-yl)-1,1,2,2-tetrafluoroethanesulfonate, triphenylsulfonium 2-(bicyclo[2.2.1]hept-2′-yl)-1,1-difluoroethanesulfonate, tri-tert-butylphenylsulfonium 2-(bicyclo[2.2.1]hept-2′-yl)-1,1-difluoroethanesulfonate, 4-cyclohexylphenyldiphenylsulfonium 2-(bicyclo[2.2.1]hept-2′-yl)-1,1-difluoroethane sulfonate, 4-methanesulfonylphenyldiphenylsulfonium 2-(bicyclo[2.2.1]hept-2′-yl)-1,1-difluoroethanesulfonate, 1-(3,5-dimethyl-4-hydroxyphenyl)tetrahydrothiophenium 2-(bicyclo[2.2.1]hept-2′-yl)-1,1-difluoroethanesulfonate, 1-(4-n-butoxynaphthyl)tetrahydrothiophenium 2-(bicyclo[2.2.1]hept-2′-yl)-1,1-difluoroethanesulfonate, and the like.

These acid generators (C) may be used either individually or in combination.

### <Solvent (D)>

The radiation-sensitive resin composition is normally used as a composition solution that is prepared by dissolving the composition in a solvent so that the total solid content is normally 1 to 50 mass %, and preferably 1 to 25 mass %, and filtering the solution using a filter having a pore size of about 0.2 μm, for example.

Examples of the solvent (C) include linear or branched ketones such as 2-butanone, 2-pentanone, 3-methyl-2-butanone, 2-hexanone, 4-methyl-2-pentanone, 3-methyl-2-pentanone, 3,3-dimethyl-2-butanone, 2-heptanone, 2-octanone; cyclic ketones such as cyclopentanone, 3-methylcyclopentanone, cyclohexanone, 2-methylcyclohexanone, 2,6-dimethylcyclohexanone, and isophorone; propylene glycol monoalkyl ether acetates such as propylene glycol monomethyl ether acetate, propylene glycol monoethyl ether acetate, propylene glycol mono-n- propyl ether acetate, propylene glycol mono-i-propyl ether acetate, propylene glycol mono-n-butyl ether acetate, propylene glycol mono-i-butyl ether acetate, propylene glycol mono-sec-butyl ether acetate, and propylene glycol mono-t-butyl ether acetate; alkyl 2-hydroxypropionates such as methyl 2-hydroxypropionate, ethyl 2-hydroxypropionate, n-propyl 2-hydroxypropionate, i-propyl 2-hydroxypropionate, n-butyl 2-hydroxypropionate, i-butyl 2-hydroxypropionate, sec-butyl 2-hydroxypropionate, and t-butyl 2-hydroxypropionate; alkyl 3-alkoxypropionates such as methyl 3-methoxypropionate, ethyl 3-methoxypropionate, methyl 3-ethoxypropionate, and ethyl 3-ethoxypropionate; n-propyl alcohol, i-propyl alcohol, n-butyl alcohol, t-butyl alcohol, cyclohexanol, ethylene glycol monomethyl ether, ethylene glycol monoethyl ether, ethylene glycol mono-n-propyl ether, ethylene glycol mono-n-butyl ether, diethylene glycol dimethyl ether, diethylene glycol diethyl ether, diethylene glycol di-n-propyl ether, diethylene glycol di-n-butyl ether, ethylene glycol monomethyl ether acetate, ethylene glycol monoethyl ether acetate, ethylene glycol mono-n-propyl ether acetate, propylene glycol monomethyl ether, propylene glycol monoethyl ether, propylene glycol mono-n-propyl ether, toluene, xylene, ethyl 2-hydroxy-2-methyl propionate, ethoxyethyl acetate, ethyl hydroxyacetate, methyl 2-hydroxy-3-methylbutyrate, 3-methoxybutylacetate, 3-methyl-3-methoxybutylacetate, 3-methyl-3-methoxybutylpropionate, 3-methyl-3-methoxybutylbutyrate, ethyl acetate, n-propyl acetate, n-butyl acetate, methyl acetoacetate, ethyl acetoacetate, methyl pyruvate, ethyl pyruvate, N-methyl pyrrolidone, N,N-dimethylformamide, N,N-dimethylacetamide, benzyl ethyl ether, di-n-hexyl ether, diethylene glycol monomethyl ether, diethylene glycol monoethyl ether, caproic acid, caprylic acid, 1-octanol, 1-nonanol, benzyl alcohol, benzyl acetate, ethyl benzoate, diethyl oxalate, diethyl maleate, γ-butyrolactone, ethylene carbonate, propylene carbonate, and the like.

Among these, linear or branched ketones, cyclic ketones, propylene glycol monoalkyl ether acetates, alkyl 2-hydroxypropionates, alkyl 3-alkoxypropionates, γ-butyrolactone, and the like are preferable.

These solvents may be used either individually or in combination.

### <Nitrogen-Containing Compound (E)>

A nitrogen-containing compound (hereinafter may be referred to as “nitrogen-containing compound (E)”) may be added to the radiation-sensitive resin composition.

The nitrogen-containing compound (E) controls diffusion of an acid generated from the acid generator upon exposure within the resist film to suppress undesired chemical reactions in the unexposed area. The storage stability of the resulting radiation-sensitive resin composition is improved by adding such an acid diffusion controller. Moreover, the acid diffusion controller further improves the resolution of the resulting resist and suppresses a change in line width of the resist pattern due to a variation in post-exposure delay (PED) from exposure to post-exposure bake, so that a composition that exhibits remarkably superior process stability can be obtained.

Examples of the nitrogen-containing compound (E) include tertiary amine compounds, other amine compounds, amide group-containing compounds, urea compounds, nitrogen-containing heterocyclic compounds, and the like.

These nitrogen-containing compounds (E) may be used either individually or in combination.

The acid diffusion controller (E) is normally used in an amount of 15 parts by mass or less, preferably 10 parts by mass or less, and more preferably 5 parts by mass or less, based on 100 parts by mass of the polymer (A) and the resin (B). If the amount of the acid diffusion controller (E) is more than 15 parts by mass, the sensitivity of the resulting resist may decrease. If the amount of the acid diffusion controller (E) is less than 0.001 parts by mass, the pattern shape or the dimensional accuracy of the resulting resist may decrease depending on the processing conditions.

### <Other Additives>

Additives such as an aliphatic additive, a surfactant, or a sensitizer may optionally be added to the radiation-sensitive resin composition.

The alicyclic additive further improves the dry etching resistance, pattern shape, adhesion to a substrate, and the like.

Examples of the alicyclic additive include adamantane derivatives such as 1-adamantanecarboxylic acid, 2-adamantanone, t-butyl-1-adamantanecarboxylate, t-butoxycarbonylmethyl 1-adamantanecarboxylate, a-butyrolactone 1-adamantanecarboxylate, di-t-butyl 1,3-adamantanedicarboxylate, t-butyl 1-adamantaneacetate, t-butoxycarbonylmethyl 1-adamantaneacetate, di-t-butyl 1,3-adamantanediacetate, and 2,5-dimethyl-2,5-di(adamantylcarbonyloxy)hexane; deoxycholates such as t-butyl deoxycholate, t-butoxycarbonylmethyl deoxycholate, 2-ethoxyethyl deoxycholate, 2-cyclohexyloxyethyl deoxycholate, 3-oxocyclohexyl deoxycholate, tetrahydropyranyl deoxycholate, and mevalonolactone deoxycholate; lithocholates such as t-butyl lithocholate, t-butoxycarbonylmethyl lithocholate, 2-ethoxyethyl lithocholate, 2-cyclohexyloxyethyl lithocholate, 3-oxocyclohexyl lithocholate, tetrahydropyranyl lithocholate, and mevalonolactone lithocholate; alkyl carboxylates such as dimethyl adipate, diethyl adipate, dipropyl adipate, di-n-butyl adipate, and di-t-butyl adipate; 3-[2-hydroxy-2,2-bis(trifluoromethyl)ethyl]tetracyclo[4.4.0.1^{2,5}. 1^{7,10}]dodecane, and the like. These alicyclic additives may be used either individually or in combination.

A surfactant improves applicability, striation, developability, and the like.

Examples of the surfactant include nonionic surfactants such as polyoxyethylene lauryl ether, polyoxyethylene stearyl ether, polyoxyethylene oleyl ether, polyoxyethylene n-octylphenyl ether, polyoxyethylene n-nonylphenyl ether, polyethylene glycol dilaurate, and polyethylene glycol distearate, commercially available products such as KP341 (manufactured by Shin-Etsu Chemical Co., Ltd.), Polyflow No. 75, Polyflow No. 95 (manufactured by Kyoeisha Chemical Co., Ltd.), EFTOP EF301, EFTOP EF303, EFTOP EF352 (manufactured by JEMCO, Inc.), MEGAFAC F171, MEGAFAC F173 (manufactured by DIC Corporation), Fluorad FC430, Fluorad FC431 (manufactured by Sumitomo 3M Ltd.), Asahi Guard AG710, Surflon S-382, Surflon SC-101, Surflon SC-102, Surflon SC-103, Surflon SC-104, Surflon SC-105, Surflon SC-106 (manufactured by Asahi Glass Co., Ltd.), and the like. These surfactants may be used either individually or in combination.

A sensitizer absorbs the energy of radiation and transmits the energy to the acid generator (C) so that the amount of acid generated increases. The sensitizer improves the apparent sensitivity of the radiation-sensitive resin composition.

Examples of the sensitizer include carbazoles, acetophenones, benzophenones, naphthalenes, phenols, biacetyl, eosine, rose bengal, pyrenes, anthracenes, phenothiazines, and the like. These sensitizers may be used either individually or in combination.

A dye or a pigment visualizes the latent image in the exposed area to reduce the effects of halation during exposure. An adhesion improver improves adhesion to a substrate. Examples of other additives include an alkali-soluble resin, a low-molecular-weight alkali-solubility controller that includes an acid-dissociable protecting group, a halation inhibitor, a preservation stabilizer, an antifoaming agent, and the like.

### <Formation of Resist Pattern>

The radiation-sensitive resin composition according to the present invention is useful as a chemically-amplified resist. When using the radiation-sensitive resin composition as a chemically-amplified resist, the acid-dissociable group included in the resin component (mainly the resin (B)) dissociates due to an acid generated from the acid generator upon exposure so that a carboxyl group is produced. As a result, the solublity of the exposed area of the resist in an alkaline developer increases. Therefore, the exposed area is dissolved (removed) in an alkaline developer to obtain a positive-tone resist pattern.

When forming a resist pattern using the radiation-sensitive resin composition according to the present invention, the resin composition solution is applied to a substrate (e.g., silicon wafer or aluminum-coated wafer) by an appropriate application method (e.g., rotational coating, cast coating, or roll coating) to form a resist film. The resist film is optionally pre-baked (hereinafter called “PB”), and exposed to form a given resist pattern. Visible rays, ultraviolet rays, deep ultraviolet rays, X-rays, charged particle rays, or the like are appropriately used for exposure depending on the type of acid generator. It is preferable to use deep ultraviolet rays (e.g., ArF excimer laser light (wavelength: 193 nm) or KrF excimer laser light (wavelength: 248 nm)). It is particularly preferable to apply ArF excimer laser light (wavelength: 193 nm).

The exposure conditions (e.g., dose) are appropriately selected depending on the composition of the radiation-sensitive resin composition, the type of additive, and the like. It is preferable to perform post-exposure bake (PEB) after exposure. The acid-dissociable group included in the resin component smoothly dissociates by performing PEB. The PEB temperature is determined depending on the composition of the radiation-sensitive resin composition, but is normally 30 to 200° C., and preferably 50 to 170° C.

In order to bring out the potential of the radiation-sensitive resin composition to a maximum extent, an organic or inorganic antireflective film may be formed on a substrate, as disclosed in Japanese Examined Patent Publication (KOKOKU) No. 6-12452 (Japanese Patent Application Publication (KOKAI) No. 59-93448), for example. A protective film may be formed on the resist film so that the resist film is not affected by basic impurities, etc. contained in the environmental atmosphere, as disclosed in Japanese Patent Application Publication (KOKAI) No. 5-188598, for example. In order to prevent outflow of the acid generator, etc. from the resist film during liquid immersion lithography, a protective film for liquid immersion lithography may be formed on the resist film, as disclosed in Japanese Patent Application Publication (KOKAI) No. 2005-352384, for example. These technologies may be used in combination.

The exposed resist film is developed to form a given resist pattern. As the developer, it is preferable to use an alkaline aqueous solution prepared by dissolving at least one alkaline compound (e.g., sodium hydroxide, potassium hydroxide, sodium carbonate, sodium silicate, sodium metasilicate, aqueous ammonia, ethylamine, n-propylamine, diethylamine, di-n-propylamine, triethylamine, methyldiethylamine, ethyldimethylamine, triethanolamine, tetramethylammonium hydroxide, pyrrole, piperidine, choline, 1,8-diazabicyclo-[5.4.0]-7-undecene, or 1,5-diazabicyclo-[4.3.0]-5-nonene) in water. The concentration of the alkaline aqueous solution is normally 10 mass % or less. If the concentration of the alkaline aqueous solution exceeds 10 mass %, an unexposed area may be dissolved in the developer.

An organic solvent may be added to the developer (alkaline aqueous solution), for example. Examples of the organic solvent include ketones such as acetone, methyl ethyl ketone, methyl i-butyl ketone, cyclopentanone, cyclohexanone, 3-methylcyclopentanone, and 2,6-dimethylcyclohexanone; alcohols such as methanol, ethanol, n-propyl alcohol, i-propyl alcohol, n-butyl alcohol, t-butyl alcohol, cyclopentanol, cyclohexanol, 1,4-hexanediol, and 1,4-hexanedimethylol; ethers such as tetrahydrofuran and dioxane; esters such as ethyl acetate, n-butyl acetate, and i-amyl acetate; aromatic hydrocarbons such as toluene and xylene; phenol, acetonylacetone, dimethylformamide; and the like. These organic solvents may be used either individually or in combination. The organic solvent is preferably used in an amount of 100 vol % or less based on the amount of the alkaline aqueous solution. If the amount of the organic solvent exceeds 100 vol %, developability may decrease so that the exposed area may remain undeveloped. An appropriate amount of surfactant etc. may also be added to the developer (alkaline aqueous solution).

After development using the developer (alkaline aqueous solution), the resist film is normally washed with water, and dried.

### Examples

The present invention is further described below by way of examples. Note that the present invention is not limited to the following examples. In the examples, the unit “parts” refers to “parts by mass” unless otherwise indicated.

In synthesis examples, the properties of each polymer were measured and evaluated as follows.

### (1) Mw and Mn

The Mw and the Mn of each polymer were determined by gel permeation chromatography (GPC) (standard: monodispersed polystyrene) using a GPC column manufactured by Tosoh Corp. (G2000HXL×2, G3000HXL×1, G4000HXL×1) (flow rate: 1.0 ml/min, column temperature: 40° C., eluant: tetrahydrofuran). The dispersibility (Mw/Mn) was calculated from the measurement results.

### (2) ¹³C-NMR Analysis

Each polymer was subjected to ¹³C-NMR analysis using “JNM-EX270” (manufactured by JEOL Ltd.).

(3) Amount of Low-Molecular-Weight Components Derived from Monomers

The amount of low-molecular-weight components was determined by high-performance liquid chromatography (HPLC) using “Intersil ODS-25 μm column” (4.6 mm (diameter)×250 mm) (manufactured by GL Sciences Inc.) (flow rate: 1.0 ml/min, eluant: acrylonitrile/0.1% phosphoric acid aqueous solution). The amount of low-molecular-weight components is indicated in mass % based on the total amount (100 mass %) of the resin.

Each synthesis example is described below.

The following monomers (M-1) to (M-11) were used to synthesize of each polymer (A) and each resin(B).

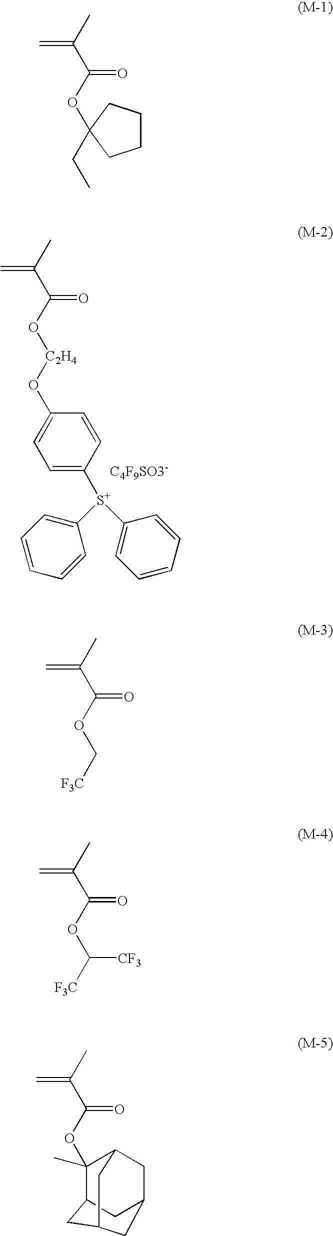

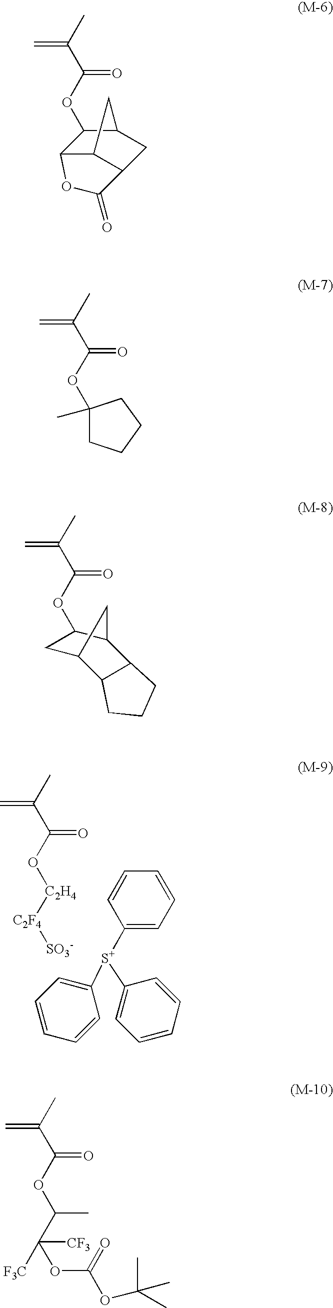

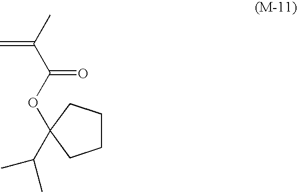

### Synthesis of Polymers (A-1) to (A-8)

Monomers shown in Table 1 and an initiator (MAIB; dimethyl-2,2′-azobisisobutyrate) were dissolved in 50 g of methyl ethyl ketone to prepare a monomer solution. The total amount of the monomers was adjusted to 50 g. The amount (mol %) of each monomer is based on the total amount of the monomers. The amount (mol %) of the initiator is based on the total amount of the monomers and the initiator.

A 500 ml three-necked flask equipped with a thermometer and a dropping funnel was charged with 50 g of methyl ethyl ketone, and purged with nitrogen for 30 minutes. The inside of the flask was heated to 80° C. with stiffing using a magnetic stirrer.

The monomer solution was then added dropwise to the flask using a dripping funnel over three hours. After the addition, the mixture was aged for three hours, and cooled to 30° C. or less to obtain a copolymer solution.

After washing the reaction solution with a hexane/methanol/water (=1:3:0.5) mixed solution, the polymer solution was extracted, followed by substitution with a propylene glycol methyl ether acetate solution using an evaporator. The amount (mass %) of the resulting polymer in the solution was measured by gas chromatography, and the yield (mass %) of the polymer and the ratio (mol %) of the repeating units included in the polymer were determined. The results are shown in Table 2.

TABLE 1

| | | | | | | | | Amount of |
|---|---|---|---|---|---|---|---|---|
| | Polymer | | Amount | | Amount | | Amount | initiator |
| | (A) | Monomer 1 | (mol %) | Monomer 2 | (mol %) | Monomer 3 | (mol %) | (mol %) |
| Polymerization | A-1 | M-1 | 65 | M-2 | 5 | M-3 | 30 | 8 |
| Example 1 | | | | | | | | |
| Polymerization | A-2 | M-1 | 60 | M-2 | 10 | M-3 | 30 | 8 |
| Example 2 | | | | | | | | |
| Polymerization | A-3 | M-1 | 80 | M-2 | 5 | M-4 | 15 | 8 |
| Example 3 | | | | | | | | |
| Polymerization | A-4 | M-1 | 55 | M-2 | 5 | M-3 | 40 | 8 |
| Example 4 | | | | | | | | |
| Polymerization | A-5 | M-1 | 67 | M-3 | 30 | M-9 | 3 | 8 |
| Example 5 | | | | | | | | |
| Polymerization | A-6 | M-1 | 55 | M-3 | 30 | M-9 | 15 | 8 |
| Example 6 | | | | | | | | |
| Polymerization | A-7 | M-1 | 85 | M-2 | 5 | M-10 | 10 | 8 |
| Example 7 | | | | | | | | |
| Polymerization | A-8 | M-11 | 85 | M-2 | 5 | M-10 | 10 | 8 |
| Example 8 | | | | | | | | |

TABLE 2

| | Polymer (A) | Yield (%) | Monomer 1 (mol %) | Monomer 2 (mol %) | Monomer 3 (mol %) |
|---|---|---|---|---|---|
| Polymerization | A-1 | 76.3 | 64.3 | 5.7 | 30.0 |
| Example 1 | | | | | |
| Polymerization | A-2 | 74.5 | 59.2 | 10.2 | 30.6 |
| Example 2 | | | | | |
| Polymerization | A-3 | 73.4 | 79.6 | 5.2 | 15.2 |
| Example 3 | | | | | |
| Polymerization | A-4 | 76.6 | 54.4 | 5.4 | 40.2 |
| Example 4 | | | | | |
| Polymerization | A-5 | 75.0 | 67.2 | 30.2 | 2.6 |
| Example 5 | | | | | |
| Polymerization | A-6 | 74.8 | 56.2 | 30.4 | 13.4 |
| Example 6 | | | | | |
| Polymerization | A-7 | 74.5 | 85.4 | 5.1 | 9.5 |
| Example 7 | | | | | |
| Polymerization | A-8 | 73.2 | 85.6 | 5.2 | 9.2 |
| Example 8 | | | | | |

### Synthesis of Resin (B-1)

21.2 g (25 mol %) of the monomer (M-1), 27.2 g (25 mol %) of the monomer (M-5), and 51.6 g (50 mol %) of the monomer (M-6) were dissolved in 200 g of 2-butanone. 3.8 g of dimethyl 2,2′-azobis(2-methylpropionate) was added to the mixture to prepare a monomer solution. A 500 ml three-necked flask was charged with 100 g of 2-butanone, and purged with nitrogen for 30 minutes. After heating the flask to 80° C. with stirring, the monomer solution was added dropwise to the flask using a dripping funnel over three hours. The monomers were polymerized for six hours from the start of the addition of the monomer solution. The polymer solution was then cooled with water to 30° C. or less, and poured into 2000 g of methanol. A precipitated white powder was collected by filtration. The white powder thus collected was washed twice with 400 g of methanol in a slurry state, collected by filtration, and dried at 50° C. for 17 hours to obtain a white powdery polymer (76 g, yield: 76%).

The polymer (copolymer) had an Mw of 6800 and an Mw/Mn ratio of 1.70. As a result of ¹³C-NMR analysis, the ratio of repeating units derived from the monomers (M-1), (M-5), and (M-6) that were contained in the polymer was found to be 24.8:24.3:50.9 (mol %). This polymer is referred to as “resin (B-1)”. The content of low-molecular-weight components derived from the monomers in the polymer was 0.03 mass % based on 100 mass % of the polymer.

### Synthesis of Resin (B-2)

33.6 g (40 mol %) of the monomer (M-7), 11.0 g (10 mol %) of the monomer (M-8), and 55.4 g (50 mol %) of the monomer (M-6) were dissolved in 200 g of 2-butanone. 4.1 g of dimethyl 2,2′-azobis(2-methylpropionate) was added to the mixture to prepare a monomer solution. A 500 ml three-necked flask was charged with 100 g of 2-butanone, and purged with nitrogen for 30 minutes. After heating the flask to 80° C. with stirring, the monomer solution was added dropwise to the flask using a dripping funnel over three hours. The monomers were polymerized for six hours from the start of the addition of the monomer solution. The polymer solution was then cooled with water to 30° C. or less, and poured into 2000 g of methanol. A precipitated white powder was collected by filtration. The white powder thus collected was washed twice with 400 g of methanol in a slurry state, collected by filtration, and dried at 50° C. for 17 hours to obtain a white powdery polymer (75 g, yield: 75%).

The polymer (copolymer) had an Mw of 7200 and an Mw/Mn ratio of 1.65. As a result of ¹³C-NMR analysis, the ratio of repeating units derived from the monomers (M-7), (M-7), and (M-6) that were contained in the polymer was found to be 40.3:9.7:50.0 (mol %). This polymer is referred to as “resin (B-2)”. The content of low-molecular-weight components derived from the monomers in the polymer was 0.03 mass % based on 100 mass % of the polymer.

### Synthesis of Resin (B-3)

35.4 g (40 mol %) of the monomer (M-1), 10.7 g (10 mol %) of the monomer (M-8), and 53.9 g (50 mol %) of the monomer (M-6) were dissolved in 200 g of 2-butanone. 4.0 g of dimethyl 2,2′-azobis(2-methylpropionate) was added to the mixture to prepare a monomer solution. A 500 ml three-necked flask was charged with 100 g of 2-butanone, and purged with nitrogen for 30 minutes. After heating the flask to 80° C. with stirring, the monomer solution was added dropwise to the flask using a dripping funnel over three hours. The monomers were polymerized for six hours from the start of the addition of the monomer solution. The polymer solution was then cooled with water to 30° C. or less, and poured into 2000 g of methanol. A precipitated white powder was collected by filtration. The white powder thus collected was washed twice with 400 g of methanol in a slurry state, collected by filtration, and dried at 50° C. for 17 hours to obtain a white powdery polymer (78 g, yield: 78%).

The polymer (copolymer) had an Mw of 7400 and an Mw/Mn ratio of 1.72. As a result of ¹³C-NMR analysis, the ratio of repeating units derived from the monomers (M-1), (M-8), and (M-6) that were contained in the polymer was found to be 40.8:8.9:50.3 (mol %). This polymer is indicated as “resin (B-3)”. The content of low-molecular-weight components derived from the monomers in the polymer was 0.03 mass % based on 100 mass % of the polymer.

### <Preparation of Radiation-Sensitive Resin Composition>

Radiation-sensitive resin compositions of Examples 1 to 20 and Comparative Example 1 were prepared by mixing the polymer (A), the resin (B), the acid generator (C), the nitrogen-containing compound (E), and the solvent (D) in a ratio shown in Tables 3 and 4. The components shown in Tables 3 and 4 other than the polymer (A) and the resin (B) are as follows. In Tables 3 and 4, the unit “parts” refers to “parts by mass” unless otherwise indicated.

### <Acid Generator (C)>

### (C-1): Compound Shown by the Following Formula

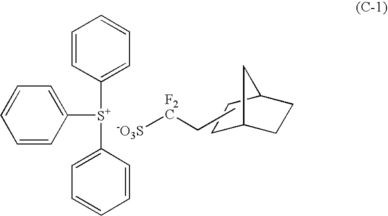

### (C-2): Compound Shown by the Following Formula

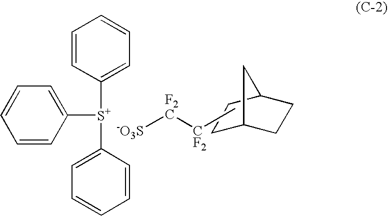

### (C-3): Compound Shown by the Following Formula

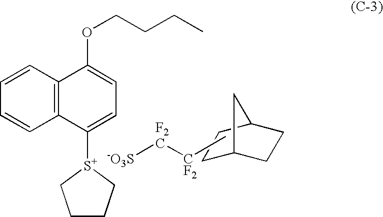

(C-4): 4-Triphenylsulfonium nonafluoro-n-butanesulfonate
(C-5): 1-(4-n-Butoxynaphthalen-1-yl)tetrahydrothiophenium nonafluoro-n-butanesulfonate

### <Solvent (E)>

(D-1): Propylene glycol monomethyl ether acetate

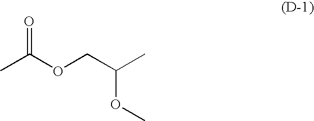

### (D-2): Cyclohexanone

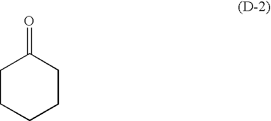

### (D-3): γ-Butyrolactone

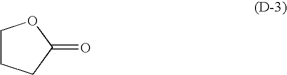

### <Nitrogen-Containing Compound (E)>

(E-1): N-t-Butoxycarbonyl-4-hydroxypiperidine

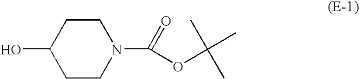

### <Evaluation of Radiation-Sensitive Resin Composition>

The following items (1) to (5) were evaluated for the radiation-sensitive resin compositions of Examples 1 to 20 and Comparative Example 1. The evaluation results are shown in Tables 5 and 6.

The evaluation methods are given below.

### (1) Measurement of Amount of Elution

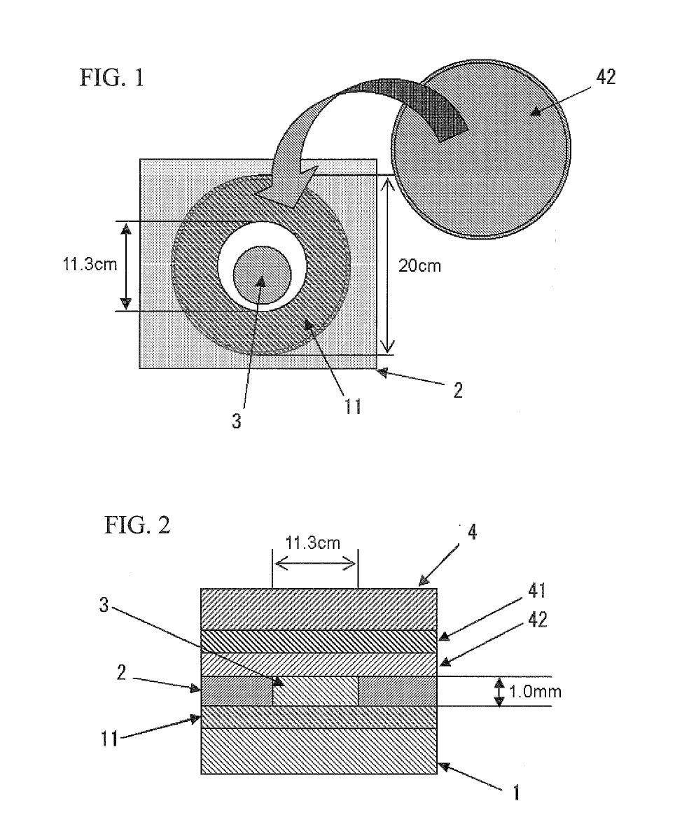

As shown in FIG. 1, a square (30×30 cm) silicone rubber sheet 2 (manufactured by Kureha Elastomer Co., Ltd., thickness: 1.0 mm) having a circular opening (diameter: 11.3 cm) at the center was placed at the center of an 8-inch silicon wafer 1 that was treated with hexamethyldisilazane (HMDS) 11 (100° C., 60 sec) using a system “CLEAN TRACK ACT8” (manufactured by Tokyo Electron, Ltd.). The circular opening of the silicone rubber sheet was filled with 10 ml of ultrapure water 3 using a 10 ml whole pipette.

An underlayer antireflective film (“ARC29A” manufactured by Bruwer Science) 41 having a thickness of 77 nm was formed on a silicon wafer 4 using the system “CLEAN TRACK ACT8”. The resist composition shown in Table 3 or 4 was spin-coated onto the underlayer antireflective film 41 using the system “CLEAN TRACK ACT8”, and baked at 115° C. for 60 seconds to form a resist film 42 having a thickness of 205 nm. The silicon wafer 4 was placed on the silicone rubber sheet 2 so that the surface of the resist film came in contact with the ultrapure water 3 and the ultrapure water 3 did not leak from the silicon sheet 2.

After 10 seconds, the silicon wafer 4 was removed, and the ultrapure water 3 was collected using a glass syringe to obtain an analysis sample. The ultrapure water recovery rate after the experiment was 95% or more.

The peak intensity of the anion site of the acid generator contained in the ultrapure water was measured using a liquid chromatograph mass spectrometer “LC-MS” (LC: “SERIES 1100” manufactured by AGILENT, MS: “Mariner” manufactured by Perseptive Biosystems, Inc.) under the following measurement conditions. The peak intensity of an aqueous solution (1 ppb, 10 ppb, or 100 ppb) of the acid generator was measured under the following measurement conditions, and a calibration curve was drawn. The amount of elution was calculated from the peak intensity using the calibration curve. Likewise, the peak intensity of an aqueous solution (1 ppb, 10 ppb, or 100 ppb) of the acid diffusion controller (nitrogen-containing compound (E-1)) was measured under the following measurement conditions, and a calibration curve was drawn. The amount of elution of the acid diffusion controller was calculated from the peak intensity using the calibration curve. A case where the amount of elution was 5.0×10⁻¹² mol/cm²/sec or more was evaluated as “Bad”, and a case where the amount of elution was less than 5.0×10⁻¹² mol/cm²/sec was evaluated as “Good”.

### (Column Conditions)

Column: “CAPCELL PAK MG” manufactured by Shiseido Co., Ltd.
Flow rate: 0.2 ml/min
Eluant: Mixture prepared by adding 0.1 mass % of formic acid to water-methanol (3:7) mixture
Measurement temperature: 35° C.

### (2) Measurement of Receding Contact Angle

A substrate (wafer) on which a film of the radiation-sensitive resin composition was formed was prepared using “DSA-10” (manufactured by KRUS). Immediately after preparation, the receding contact angle was measured by the following method at a temperature of 23° C. (room temperature) and a humidity of 45% under atmospheric pressure.

Specifically, the position of the wafer stage of the DSA-10 (manufactured by KRUS) was adjusted, and the substrate was placed on the stage. After injecting water into the needle, the position of the needle was adjusted to the initial position at which a waterdrop can be formed on the substrate. Water was discharged from the needle to form a waterdrop (25 μl) on the substrate. After removing the needle, the needle was moved downward to the initial position, and introduced into the waterdrop. The waterdrop was sucked through the needle for 90 seconds at a rate of 10 μl/min, and the contact angle formed by the liquid surface and the substrate was measured every second (90 times in total). The average value of twenty contact angle measured values (20 seconds) after the measured value became stable was calculated, and taken as the receding contact angle (°).

### (3) Sensitivity

A 12-inch silicon wafer on which an (thickness: 77 nm) was formed (“ARC29A” manufactured by Bruwer Science) was used as a substrate. The underlayer antireflective film was formed using a system “CLEAN TRACK ACT8” (manufactured by Tokyo Electron Ltd.).

The resist composition shown in Table 3 or 4 was spin-coated onto the substrate using the system “CLEAN TRACK ACT8”, and pre-baked under conditions shown in Tables 5 and 6 to form a resist film having a thickness of 120 nm. The resist film was exposed through a mask pattern using an ArF excimer laser exposure system (“NSR S306C” manufactured by Nikon Corp., NA=0.78, sigma=0.93/0.69). After performing PEB under conditions shown in Tables 5 and 6, the resist film was developed at 23° C. for 30 seconds using a 2.38 mass % tetramethylammonium hydroxide aqueous solution, washed with water, and dried to form a positive-tone resist pattern. An optimum dose at which a 1:1 line-and-space (1L1S) pattern having a line width of 90 nm was formed was taken as sensitivity. A scanning electron microscope (“S-9380” manufactured by Hitachi High-Technologies Corporation) was used for the measurement.

### (4) Cross-Sectional Pattern Shape (Pattern Shape)

The cross-sectional shape of the 90 nm line-and-space pattern obtained in (3) was observed using a system “S-4800” (manufactured by Hitachi High-Technologies Corp.) to measure the line width A of the uppermost area of the pattern and the line width B of the lowermost area of the pattern. A case where a rectangular pattern that satisfied the relationship “0.7≦A/B≦1” was formed was evaluated as “Good”, and a case where a T-top pattern that did not satisfy the relationship “0.7≦A/B≦1” was formed was evaluated as “Bad”.

### (5) Number of Defects

A 12-inch silicon wafer on which an underlayer antireflective film (thickness: 77 nm) was formed (“ARC29A” manufactured by Bruwer Science) was used as a substrate. The underlayer antireflective film was formed using a system “CLEAN TRACK ACT8” (manufactured by Tokyo Electron Ltd.).

The resist composition shown in Table 3 or 4 was spin-coated onto the substrate using the system “CLEAN TRACK ACT8”, and pre-baked under conditions shown in Tables 5 and 6 to form a resist film having a thickness of 120 nm. The resist film was then rinsed with pure water for 90 seconds. The resist film was exposed through a mask pattern using an ArF excimer laser exposure system (“NSR S306C” manufactured by Nikon Corp.) (NA=0.78, sigma=0.85, ½ annular). The resist film was then rinsed with pure water for 90 seconds. After performing PEB under conditions shown in Tables 5 and 6, the resist film was developed at 23° C. for 60 seconds using a 2.38 mass % tetramethylammonium hydroxide aqueous solution, washed with water, and dried to form a positive-tone resist pattern. A hole pattern (width: 1000 nm) was formed over the entire wafer at an optimum dose at which a hole pattern having a width of 1000 nm was formed to obtain a defect detection wafer. A scanning electron microscope (“S-9380” manufactured by Hitachi High-Technologies Corporation) was used for the measurement.

The number of defects of the hole pattern (width: 1000 nm) was measured using a system “KLA2351” (manufactured by KLA Tencor Corp.). Defects measured using the system “KLA2351” were observed using a scanning electron microscope (“S-9380” manufactured by Hitachi High Technologies Corp.), and classified into a defect due to the resist and a defect due to foreign matter. A case where the number of defects due to the resist was 100 or more per wafer was evaluated as “Bad”, and a case where the number of defects due to the resist was less than 100 per wafer was evaluated as “Good”.

Note that the term “defects due to the resist” refers to a residual defect due to insufficient dissolution during development, a protrusion defect due to undissolved resin in the solvent, and the like, and the term “defects due to foreign matter” refers to a defect that occurs due to dust, uneven application, bubbles, or the like.

TABLE 3

| | | | | Nitrogen- | |
|---|---|---|---|---|---|
| | | | Acid | containing | |
| | Polymer | | generator | compound | |
| | (A) | Resin (B) | (C) | (E) | Solvent (D) |
| | (parts) | (parts) | (parts) | (parts) | (parts) |
| Example 1 | A-1 (5) | B-1 (100) | C-1 (7.5) | E-1 (0.65) | D-1 (1500) |
| | | | | | D-2 (650) |
| | | | | | D-3 (30) |
| Example 2 | A-2 (5) | B-1 (100) | C-1 (7.5) | E-1 (0.65) | D-1 (1500) |
| | | | | | D-2 (650) |
| | | | | | D-3 (30) |
| Example 3 | A-3 (5) | B-1 (100) | C-1 (7.5) | E-1 (0.65) | D-1 (1500) |
| | | | | | D-2 (650) |
| | | | | | D-3 (30) |
| Example 4 | A-4 (5) | B-1 (100) | C-1 (7.5) | E-1 (0.65) | D-1 (1500) |
| | | | | | D-2 (650) |
| | | | | | D-3 (30) |
| Example 5 | A-1 (5) | B-1 (100) | C-1 (7.5) | E-1 (0.65) | D-1 (1500) |
| | | | | | D-2 (650) |
| | | | | | D-3 (30) |
| Example 6 | A-1 (5) | B-1 (100) | C-2 (8.0) | E-1 (0.65) | D-1 (1500) |
| | | | | | D-2 (650) |
| | | | | | D-3 (30) |
| Example 7 | A-1 (5) | B-1 (100) | C-3 (10) | E-1 (0.65) | D-1 (1500) |
| | | | | | D-2 (650) |
| | | | | | D-3 (30) |
| Example 8 | A-1 (5) | B-1 (100) | C-4 (5.0) | E-1 (0.65) | D-1 (1500) |
| | | | C-5 (2.5) | | D-2 (650) |
| | | | | | D-3 (30) |
| Example 9 | A-1 (5) | B-2 (100) | C-1 (7.5) | E-1 (0.65) | D-1 (1500) |
| | | | | | D-2 (650) |
| | | | | | D-3 (30) |
| Example 10 | A-1 (5) | B-3 (100) | C-1 (7.5) | E-1 (0.65) | D-1 (1500) |
| | | | | | D-2 (650) |
| | | | | | D-3 (30) |

TABLE 4

| | | | | Nitrogen- | |
|---|---|---|---|---|---|
| | | | | containing | |
| | Polymer | | Acid | compound | |
| | (A) | Resin (B) | generator | (E) | Solvent (D) |
| | (parts) | (parts) | (C) (parts) | (parts) | (parts) |
| Example 11 | A-5 (5) | B-1 (100) | C-1 (7.5) | E-1 (0.65) | D-1 (1500) |
| | | | | | D-2(650) |
| | | | | | D-3(30) |
| Example 12 | A-6 (5) | B-1 (100) | C-4 (5.0) | E-1 (0.65) | D-1 (1500) |
| | | | C-5 (2.5) | | D-2(650) |
| | | | | | D-3(30) |
| Example 13 | A-5 (5) | B-1 (100) | C-1 (7.5) | E-1 (0.65) | D-1 (1500) |
| | | | | | D-2(650) |
| | | | | | D-3(30) |
| Example 14 | A-6 (5) | B-1 (100) | C-4 (5.0) | E-1 (0.65) | D-1 (1500) |
| | | | C-5 (2.5) | | D-2 (650) |
| | | | | | D-3 (30) |
| Example 15 | A-7 (5) | B-1 (100) | C-1 (7.5) | E-1 (0.65) | D-1 (1500) |
| | | | | | D-2 (650) |
| | | | | | D-3 (30) |
| Example 16 | A-7 (5) | B-1 (100) | C-2 (8.0) | E-1 (0.65) | D-1 (1500) |
| | | | | | D-2 (650) |
| | | | | | D-3 (30) |
| Example 17 | A-7 (5) | B-1 (100) | C-3 (10) | E-1 (0.65) | D-1 (1500) |
| | | | | | D-2 (650) |
| | | | | | D-3 (30) |
| Example 18 | A-8 (5) | B-1 (100) | C-1 (7.5) | E-1 (0.65) | D-1 (1500) |
| | | | | | D-2 (650) |
| | | | | | D-3 (30) |
| Example 19 | A-8 (5) | B-1 (100) | C-2 (8.0) | E-1 (0.65) | D-1 (1500) |
| | | | | | D-2 (650) |
| | | | | | D-3 (30) |
| Example 20 | A-8 (5) | B-1 (100) | C-3 (10) | E-1 (0.65) | D-1 (1500) |
| | | | | | D-2 (650) |
| | | | | | D-3 (30) |
| Comparative | — | B-1 (100) | C-1 (7.5) | E-1 (0.65) | D-1 (1500) |
| Example 1 | | | | | D-2 (650) |
| | | | | | D-3 (30) |

TABLE 5

| | Bake | PEB | Amount | Receding contact | Sensitivity | | Number of |
|---|---|---|---|---|---|---|---|
| | (temp./time) | (temp./time) | of elution | angle (°) | (mj/cm²) | Pattern shape | defects |
| Example 1 | 120° C./60 s | 105° C./60 s | Good | 72.3 | 40 | Good | Good |
| Example 2 | 120° C./60 s | 105° C./60 s | Good | 70.0 | 37 | Good | Good |
| Example 3 | 120° C./60 s | 105° C./60 s | Good | 81.7 | 40 | Good | Good |
| Example 4 | 120° C./60 s | 105° C./60 s | Good | 76.0 | 38 | Good | Good |
| Example 5 | 120° C./60 s | 105° C./60 s | Good | 70.0 | 37 | Good | Good |
| Example 6 | 120° C./60 s | 105° C./60 s | Good | 81.7 | 40 | Good | Good |
| Example 7 | 120° C./60 s | 105° C./60 s | Good | 73.3 | 44 | Good | Good |
| Example 8 | 120° C./60 s | 105° C./60 s | Good | 73.2 | 40 | Good | Good |
| Example 9 | 120° C./60 s | 115° C./60 s | Good | 74.2 | 36 | Good | Good |
| Example 10 | 120° C./60 s | 105° C./60 s | Good | 72.3 | 36 | Good | Good |

TABLE 6

| | Bake | PEB | Amount of | Receding contact | Sensitivity | | Number of |
|---|---|---|---|---|---|---|---|
| | (temp./time) | (temp./time) | elution | angle (°) | (mj/cm²) | Pattern shape | defects |
| Example 11 | 120° C./60 s | 110° C./60 s | Good | 74.6 | 44 | Good | Good |
| Example 12 | 120° C./60 s | 110° C./60 s | Good | 70.6 | 42 | Good | Good |
| Example 13 | 120° C./60 s | 110° C./60 s | Good | 72.3 | 46 | Good | Good |
| Example 14 | 120° C./60 s | 110° C./60 s | Good | 70.1 | 43 | Good | Good |
| Example 15 | 120° C./60 s | 105° C./60 s | Good | 75.4 | 38 | Good | Good |
| Example 16 | 120° C./60 s | 105° C./60 s | Good | 76.5 | 38 | Good | Good |
| Example 17 | 120° C./60 s | 105° C./60 s | Good | 73.3 | 36.5 | Good | Good |
| Example 18 | 120° C./60 s | 105° C./60 s | Good | 80.7 | 37 | Good | Good |
| Example 19 | 120° C./60 s | 105° C./60 s | Good | 81.0 | 36.5 | Good | Good |
| Example 20 | 120° C./60 s | 105° C./60 s | Good | 78.7 | 36 | Good | Good |
| Comparative | 100° C./60 s | 105° C./60 s | Bad | 61.0 | 39 | Good | Bad |
| Example 1 | | | | | | | |

As is clear from Tables 5 and 6, when using the radiation-sensitive resin composition for liquid immersion lithography that includes the novel polymer (A), the amount of elution into the immersion liquid during liquid immersion lithography was small, a high receding contact angle and an excellent pattern shape were obtained, and the number of defects was small. Therefore, the radiation-sensitive resin composition is expected to be advantageous for advanced lithography.

1. A radiation-sensitive resin composition comprising (A) a polymer, (B) an acid-labile group-containing resin, (C) a radiation-sensitive acid generator, and (D) a solvent, the polymer (A) comprising a repeating unit shown by a following general formula (1) and a repeating unit shown by a following general formula (2), 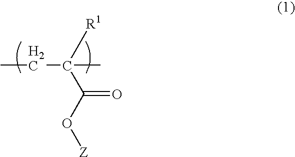
wherein R¹ represents a hydrogen atom, a methyl group, or a trifluoromethyl group, and Z represents a group that includes a structure that generates an acid upon exposure to light, 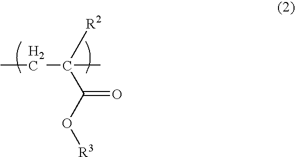
wherein R² represents a hydrogen atom, a methyl group, or a trifluoromethyl group, and R³ represents a linear or branched alkyl group having 1 to 6 carbon atoms in which at least one hydrogen atom is substituted with a fluorine atom, an alicyclic hydrocarbon group having 4 to 20 carbon atoms in which at least one hydrogen atom is substituted with a fluorine atom, or a derivative thereof.

2. The radiation-sensitive resin composition according to claim 1, wherein the repeating unit shown by the general formula (1) is at least one of a repeating unit shown by a following general formula (1-1) and a repeating unit shown by a following general formula (1-2), 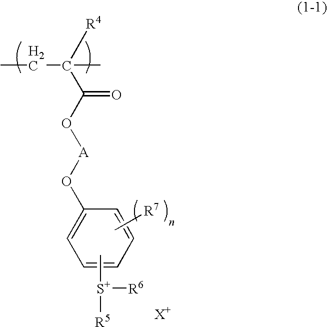
wherein R⁴ represents a hydrogen atom, a methyl group, or a trifluoromethyl group, R⁵, R⁶, and R⁷ individually represent a substituted or unsubstituted linear or branched alkyl group having 1 to 10 carbon atoms, a substituted or unsubstituted linear or branched alkoxy group having 1 to 10 carbon atoms, or a substituted or unsubstituted aryl group having 3 to 10 carbon atoms, n represents an integer from 0 to 3, A represents a methylene group, a linear or branched alkylene group having 2 to 10 carbon atoms, or an arylene group having 3 to 10 carbon atoms, and X⁻ represents a counter ion of S⁺, 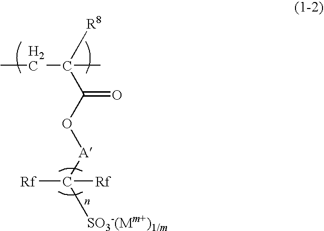
wherein R⁸ represents a hydrogen atom, a methyl group, or a trifluoromethyl group, Rf represents a fluorine atom or a linear or branched perfluoroalkyl group having 1 to 10 carbon atoms, A′ represents a single bond or a divalent organic group, M^{m+} represents a metal ion or an onium cation, m represents an integer from 1 to 3, and n represents an integer from 1 to 8.

3. The radiation-sensitive resin composition according to claim 1, wherein the polymer (A) further comprises a repeating unit shown by a following general formula (3), 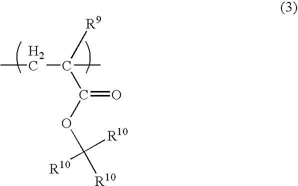
wherein R⁹ represents a hydrogen atom, a methyl group, or a trifluoromethyl group, and R¹⁰ individually represent a monovalent alicyclic hydrocarbon group having 4 to 20 carbon atoms, a derivative thereof, or a linear or branched alkyl group having 1 to 4 carbon atoms, provided that two of R¹⁰ may bond to form a divalent alicyclic hydrocarbon group having 4 to 20 carbon atoms or a derivative thereof together with the carbon atom that is bonded to the two R¹⁰.

4. The radiation-sensitive resin composition according to claim 1, wherein the content of the polymer (A) is 1 to 30 mass % based on 100 mass % of the radiation-sensitive resin composition.

5. A polymer comprising a repeating unit shown by a following general formula (1) and a repeating unit shown by a following general formula (2), 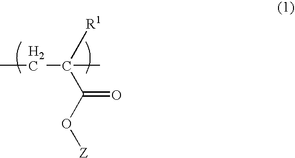
wherein R¹ represents a hydrogen atom, a methyl group, or a trifluoromethyl group, and Z represents a group that includes a structure that generates an acid upon exposure to light, 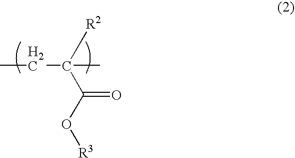
wherein R² represents a hydrogen atom, a methyl group, or a trifluoromethyl group, and R³ represents a linear or branched alkyl group having 1 to 6 carbon atoms in which at least one hydrogen atom is substituted with a fluorine atom, an alicyclic hydrocarbon group having 4 to 20 carbon atoms in which at least one hydrogen atom is substituted with a fluorine atom, or a derivative thereof.

6. The polymer according to claim 5, wherein the repeating unit shown by the general formula (1) is at least one of a repeating unit shown by a following general formula (1-1) and a repeating unit shown by a following general formula (1-2), 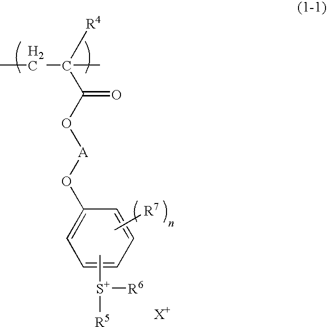
wherein R⁴ represents a hydrogen atom, a methyl group, or a trifluoromethyl group, R⁵, R⁶, and R⁷ individually represent a substituted or unsubstituted linear or branched alkyl group having 1 to 10 carbon atoms, a substituted or unsubstituted linear or branched alkoxy group having 1 to 10 carbon atoms, or a substituted or unsubstituted aryl group having 3 to 10 carbon atoms, n represents an integer from 0 to 3, A represents a methylene group, a linear or branched alkylene group having 2 to 10 carbon atoms, or an arylene group having 3 to 10 carbon atoms, and X⁻ represents a counter ion of S⁺, 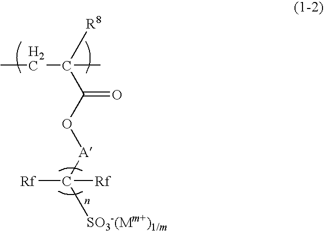
wherein R⁸ represents a hydrogen atom, a methyl group, or a trifluoromethyl group, Rf represents a fluorine atom or a linear or branched perfluoroalkyl group having 1 to 10 carbon atoms, A′ represents a single bond or a divalent organic group, M^{m+} represents a metal ion or an onium cation, m represents an integer from 1 to 3, and n represents an integer from 1 to 8.

7. The polymer according to claim 5, further comprising a repeating unit shown by a following general formula (3), 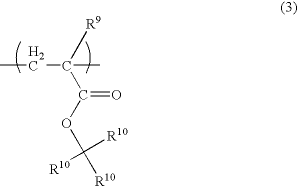
wherein R⁹ represents a hydrogen atom, a methyl group, or a trifluoromethyl group, and R¹⁰ individually represent a monovalent alicyclic hydrocarbon group having 4 to 20 carbon atoms, a derivative thereof, or a linear or branched alkyl group having 1 to 4 carbon atoms, provided that two of R¹⁰ may bond to form a divalent alicyclic hydrocarbon group having 4 to 20 carbon atoms or a derivative thereof together with the carbon atom that is bonded to the two R10.
